(19) United States
(12) Patent Application Publication
(10) Pub. No.: US 2026/0093796 A1
(43) Pub. Date: Apr. 2, 2026

(54) METHOD OF ACCESSING INFORMATION OF A VEHICLE

(71) Applicant: Volvo Car Corporation, Göteborg (SE)

(72) Inventors: Adina-Maria SOROSTINEAN, Gothenburg (SE); Madhan Kumar BALASUBRAMANI, Västra Frölunda (SE); Meng LIU, Gothenburg (SE); Sayali KHERATKAR, Göteborg (SE); Megha BENNUR, Göteborg (SE); Karthikeyan RAVINDRAN, Göteborg (SE)

(73) Assignee: Volvo Car Corporation, Göteborg (SE)

(21) Appl. No.: 18/898,960

(22) Filed: Sep. 27, 2024

(51) Int. Cl. G06F 21/44; G07C 5/00; G07C 5/04

(52) U.S. Cl. CPC G06F 21/44; G07C 5/008; G07C 5/04

(57) ABSTRACT

A system is described. The system comprises: a processor storing instructions in non-transitory memory. The processor is operable to: receive a connection request from a responder device associated with a responder; validate an authentication code associated with the responder; establish a connection with the responder device; receive a request for status information of a vehicle from the responder device; determine a role and an authorization level of the responder from a database; select, using a machine learning model, a segment of status information of the vehicle based on the role and the authorization level of the responder; and transmit the segment of the status information to the responder device.

### FIELD OF THE INVENTION

The present disclosure relates generally to accessing vehicle information. More specifically, the present disclosure relates to a system and method of accessing information of a vehicle.

### BACKGROUND

Currently, police and other authorities face significant challenges in accessing essential vehicle information. This process typically depends on the driver to provide details, which can be time-consuming and susceptible to inaccuracies. For instance, when a police officer stops a car at the side of the road, they may be able to identify the vehicle's owner based on the license plate, but they do not have immediate information about the driver or the current situation inside the car until they approach it. The lack of immediate access to comprehensive data such as Vehicle Identification Number (VIN), maintenance history, accident records, and legal compliance documents can lead to delays and inefficiencies.

Therefore, there is a long-felt need for a system and method of accessing information of a vehicle.

### SUMMARY

The following presents a summary to provide a basic understanding of one or more embodiments described herein. This summary is not intended to identify key or critical elements or delineate any scope of the different embodiments and/or any scope of the claims. The sole purpose of the summary is to present some concepts in a simplified form as a prelude to the more detailed description presented herein.

In one or more embodiments described herein, systems, devices, computer-implemented methods, methods, apparatus and/or computer program products are presented that facilitate accessing information of a vehicle.

In an aspect, a system is described. The system comprises: a processor storing instructions in non-transitory memory. The processor is operable to: receive a connection request from a responder device associated with a responder; validate an authentication code associated with the responder; establish a connection with the responder device; receive a request for status information of a vehicle from the responder device; determine a role and an authorization level of the responder from a database; select, using a machine learning model, a segment of status information of the vehicle based on the role and the authorization level of the responder; and transmit the segment of status information to the responder device.

In one aspect, a method is described. The method comprises: receiving a connection request from a responder device associated with a responder; validating an authentication code associated with the responder; establish a connection with the responder device; receiving a request for status information of a vehicle from the responder device; determining a role and an authorization level of the responder from a database; selecting, using a machine learning model, a segment of status information of the vehicle based on the role and the authorization level of the responder; and transmitting the segment of status information to the responder device.

In one aspect, a non-transitory computer readable storage medium is described. The non-transitory computer readable storage medium comprising a sequence of instructions, which when executed by a processor causes: receiving a connection request from a responder device associated with a responder; validating an authentication code associated with the responder; establish a connection with the responder device; receiving a request for status information of a vehicle from the responder device; determining a role and an authorization level of the responder from a database; selecting, using a machine learning model, a segment of status information of the vehicle based on the role and the authorization level of the responder; and transmitting the segment of status information to the responder device.

In one aspect, a vehicle is described. The vehicle comprises: a processor storing instructions in non-transitory memory. The processor is operable to: receive a request for connection from a responder; accept a request for vehicle information from the responder, with special codes for authorized access; authenticate the request and ensure only authorized first responders can access the information; obtain vehicle information including Vehicle Identification Number (VIN), insurance information, driver's information, and recent function data; and send the information to the responder upon successful verification.

The methods and systems disclosed herein may be implemented in any means for achieving various aspects and may be executed in a form of a non-transitory machine-readable medium embodying a set of instructions that, when executed by a machine, causes the machine to perform any of the operations disclosed herein. Other features will be apparent from the accompanying drawings and from the detailed description that follows.

### BRIEF DESCRIPTION OF THE FIGURES

These and other aspects of the present disclosure will now be described in more detail, with reference to the appended drawings showing exemplary embodiments, in which:

FIG. 1 illustrates a system, according to one or more embodiments.

FIG. 2 illustrates a method, according to one or more embodiments.

FIG. 3 illustrates a non-transitory computer readable storage medium block diagram, according to one or more embodiments.

FIG. 4 illustrates a general information segment received from a system, according to one or more embodiments.

FIG. 5 illustrates owner information segment received from a system according to one or more embodiments.

FIG. 6 illustrates an operational data segment received from a system according to one or more embodiments.

FIG. 7 illustrates an incident-specific data segment received from a system according to one or more embodiments.

FIG. 8 illustrates case history data segment received from a system according to one or more embodiments.

FIG. 9 illustrates a block diagram of a system for accessing status information of a vehicle according to one or more embodiments.

FIG. 10 illustrates a block diagram of a system integrated into a vehicle according to one or more embodiments FIG. 11A illustrates a process of accessing the status information of a vehicle by a first responder as the vehicle enters a service center according to one or more embodiments.

FIG. 11B illustrates a process of accessing the status information of a vehicle by a second responder when the vehicle is undergoing maintenance at the service center according to one or more embodiments.

FIG. 11C illustrates a process of accessing the status information of the vehicle by a third responder when managing comprehensive vehicle records at the service center according to one or more embodiments.

FIG. 11D illustrates selection of segments based on the role and authorization level of the responder according to one or more embodiments herein.

FIG. 12 illustrates a communication flow between a system, a vehicle, and a responder device, according to one or more embodiments

FIG. 13 shows an example block diagram for a machine learning model used in selecting a segment of status information of a vehicle according to one or more embodiments

FIG. 14A shows a structure of the neural network/machine learning model with a feedback loop.

FIG. 14B shows a structure of the neural network/machine learning model with reinforcement learning.

FIG. 15A shows a block diagram of the cyber security module in view of the system and server.

FIG. 15B shows an embodiment of the cyber security module.

FIG. 15C shows another embodiment of the cyber security module.

Other features of the present embodiments will be apparent from the accompanying drawings and from the detailed description that follows.

### DETAILED DESCRIPTION

For simplicity and clarity of illustration, the figures illustrate the general manner of construction. The description and figures may omit the descriptions and details of well-known features and techniques to avoid unnecessarily obscuring the present disclosure. The figures exaggerate the dimensions of some of the elements relative to other elements to help improve understanding of embodiments of the present disclosure. The same reference numeral in different figures denotes the same element.

Although the detailed description herein contains many specifics for the purpose of illustration, a person of ordinary skill in the art will appreciate that many variations and alterations to the details are considered to be included herein.

Accordingly, the embodiments herein are without any loss of generality to, and without imposing limitations upon, any claims set forth. The terminology used herein is for the purpose of describing particular embodiments only and is not limiting. Unless defined otherwise, all technical and scientific terms used herein have the same meaning as commonly understood by one with ordinary skill in the art to which this disclosure belongs.

Unless defined otherwise, all technical and scientific terms used herein have the same meaning as commonly understood by one with ordinary skill in the art.

As used herein, the articles “a” and “an” used herein refer to one or to more than one (i.e., to at least one) of the grammatical object of the article. By way of example, “an element” means one element or more than one element. Moreover, usage of articles “a” and “an” in the subject specification and annexed drawings construe to mean “one or more” unless specified otherwise or clear from context to mean a singular form.

As used herein, the terms “example” and/or “exemplary” mean serving as an example, instance, or illustration. For the avoidance of doubt, such examples do not limit the herein described subject matter. In addition, any aspect or design described herein as an “example” and/or “exemplary” is not necessarily preferred or advantageous over other aspects or designs, nor does it preclude equivalent exemplary structures and techniques known to those of ordinary skill in the art.

As used herein, the terms “first,” “second,” “third,” and the like in the description and in the claims, if any, distinguish between similar elements and do not necessarily describe a particular sequence or chronological order. The terms are interchangeable under appropriate circumstances such that the embodiments herein are, for example, capable of operation in sequences other than those illustrated or otherwise described herein. Furthermore, the terms “include,” “have,” and any variations thereof, cover a non-exclusive inclusion such that a process, method, system, article, device, or apparatus that comprises a list of elements is not necessarily limiting to those elements, but may include other elements not expressly listed or inherent to such process, method, system, article, device, or apparatus.

As used herein, the terms “left,” “right,” “front,” “back,” “top,” “bottom,” “over,” “under” and the like in the description and in the claims, if any, are for descriptive purposes and not necessarily for describing permanent relative positions. The terms so used are interchangeable under appropriate circumstances such that the embodiments of the apparatus, methods, and/or articles of manufacture described herein are, for example, capable of operation in other orientations than those illustrated or otherwise described herein.

No element act, or instruction used herein is critical or essential unless explicitly described as such. Furthermore, the term “set” includes items (e.g., related items, unrelated items, a combination of related items and unrelated items, etc.) and may be interchangeable with “one or more”. Where only one item is intended, the term “one” or similar language is used. Also, the terms “has,” “have,” “having,” or the like are open-ended terms. Further, the phrase “based on” means “based, at least in part, on” unless explicitly stated otherwise.

As used herein, the terms “system,” “device,” “unit,” and/or “module” refer to a different component, component portion, or component of the various levels of the order. However, other expressions that achieve the same purpose may replace the terms.

As used herein, the terms “couple,” “coupled,” “couples,” “coupling,” and the like refer to connecting two or more elements mechanically, electrically, and/or otherwise. Two or more electrical elements may be electrically coupled together, but not mechanically or otherwise coupled together. Coupling may be for any length of time, e.g., permanent, or semi-permanent or only for an instant. “Electrical coupling” includes electrical coupling of all types. The absence of the word “removably,” “removable,” and the like, near the word “coupled” and the like does not mean that the coupling, etc., in question is or is not removable.

As used herein, the term “or” means an inclusive “or” rather than an exclusive “or.” That is, unless specified otherwise, or clear from context. “X employs A or B” means any of the natural inclusive permutations. That is, if X employs A; X employs B; or X employs both A and B, then “X employs A or B” is satisfied under any of the foregoing instances.

As used herein, two or more elements or modules are “integral” or “integrated” if they operate functionally together. Two or more elements are “non-integral” if each element can operate functionally independently.

As used herein, the term “real-time” refers to operations conducted as soon as practically possible upon occurrence of a triggering event. A triggering event can include receipt of data necessary to execute a task or to otherwise process information. Because of delays inherent in transmission and/or in computing speeds, the term “real-time” encompasses operations that occur in “near” real-time or somewhat delayed from a triggering event. In a number of embodiments, “real-time” can mean real-time less a time delay for processing (e.g., determining) and/or transmitting data. The particular time delay can vary depending on the type and/or amount of the data, the processing speeds of the hardware, the transmission capability of the communication hardware, the transmission distance, etc. However, in many embodiments, the time delay can be less than approximately one second, two seconds, five seconds, or ten seconds.

As used herein, the term “approximately” can mean within a specified or unspecified range of the specified or unspecified stated value. In some embodiments, “approximately” can mean within plus or minus ten percent of the stated value. In other embodiments, “approximately” can mean within plus or minus five percent of the stated value. In further embodiments, “approximately” can mean within plus or minus three percent of the stated value. In yet other embodiments, “approximately” can mean within plus or minus one percent of the stated value.

Digital electronic circuitry, or in computer software, firmware, or hardware, including the structures disclosed in this specification and their structural equivalents, or in combinations of one or more of them may realize the implementations and all of the functional operations described in this specification. Implementations may be as one or more computer program products, i.e., one or more modules of computer program instructions encoded on a computer readable medium for execution by, or to control the operation of, data processing apparatus. The computer readable medium may be a machine-readable storage device, a machine-readable storage substrate, a memory device, a composition of matter affecting a machine-readable propagated signal, or a combination of one or more of them. The term “computing system” encompasses all apparatus, devices, and machines for processing data, including by way of example, a programmable processor, a computer, or multiple processors or computers. The apparatus may include, in addition to hardware, code that creates an execution environment for the computer program in question, e.g., code that constitutes processor firmware, a protocol stack, a database management system, an operating system, or a combination of one or more of them. A propagated signal is an artificially generated signal (e.g., a machine-generated electrical, optical, or electromagnetic signal) that encodes information for transmission to a suitable receiver apparatus.

The actual specialized control hardware or software code used to implement these systems and/or methods is not limiting to the implementations. Thus, any software and any hardware can implement the systems and/or methods based on the description herein without reference to specific software code.

A computer program (also known as a program, software, software application, script, or code) is written in any appropriate form of programming language, including compiled or interpreted languages. Any appropriate form, including a standalone program or a module, component, subroutine, or other unit suitable for use in a computing environment may deploy it. A computer program does not necessarily correspond to a file in a file system. A program may be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program may execute on one computer or on multiple computers that are located at one site or distributed across multiple sites and interconnected by a communication network.

One or more programmable processors, executing one or more computer programs to perform functions by operating on input data and generating output, perform the processes and logic flows described in this specification. The processes and logic flows may also be performed by, and apparatus may also be implemented as, special purpose logic circuitry, for example, without limitation, a Field Programmable Gate Array (FPGA), an Application Specific Integrated Circuit (ASIC), Application Specific Standard Products (ASSPs), System-On-a-Chip (SOC) systems, Complex Programmable Logic Devices (CPLDs), etc.

Processors suitable for the execution of a computer program include, by way of example, both general and special purpose microprocessors, and any one or more processors of any appropriate kind of a digital computer. A processor will receive instructions and data from a read-only memory or a random-access memory or both. Elements of a computer can include a processor for performing instructions and one or more memory devices for storing instructions and data. A computer will also include, or is operatively coupled to receive data, transfer data or both, to/from one or more mass storage devices for storing data e.g., magnetic disks, magneto optical disks, optical disks, or solid-state disks. However, a computer need not have such devices. Moreover, another device, e.g., a mobile telephone, a personal digital assistant (PDA), a mobile audio player, a Global Positioning System (GPS) receiver, etc., may embed a computer. Computer readable media suitable for storing computer program instructions and data include all forms of non-volatile memory, media and memory devices, including, by way of example, semiconductor memory devices (e.g., Erasable Programmable Read-Only Memory (EPROM), Electronically Erasable Programmable Read-Only Memory (EEPROM), and flash memory devices), magnetic disks (e.g., internal hard disks or removable disks), magneto optical disks (e.g. Compact Disc Read-Only Memory (CD ROM) disks, Digital Versatile Disk-Read-Only Memory (DVD-ROM) disks) and solid-state disks. Special purpose logic circuitry may supplement or incorporate the processor and the memory.

To provide for interaction with a user, a computer may have a display device, e.g., a Cathode Ray Tube (CRT) or Liquid Crystal Display (LCD) monitor, for displaying information to the user, and a keyboard and a pointing device, e.g., a mouse or a trackball, by which the user may provide input to the computer. Other kinds of devices provide for interaction with a user as well. For example, feedback to the user may be any appropriate form of sensory feedback, e.g., visual feedback, auditory feedback, or tactile feedback; and a computer may receive input from the user in any appropriate form, including acoustic, speech, or tactile input.

A computing system that includes a back-end component, e.g., a data server, or that includes a middleware component, e.g., an application server, or that includes a front-end component, e.g., a client computer having a graphical user interface or a Web browser through which a user may interact with an implementation, or any appropriate combination of one or more such back-end, middleware, or front-end components, may realize implementations described herein. Any appropriate form or medium of digital data communication, e.g., a communication network may interconnect the components of the system. Examples of communication networks include a Local Area Network (LAN) and a Wide Area Network (WAN), e.g., Intranet and Internet.

The computing system may include clients and servers. A client and server are remote from each other and typically interact through a communication network. The relationship of the client and server arises by virtue of computer programs running on the respective computers and having a client-server relationship to each other.

Embodiments may comprise or utilize a special purpose or general purpose computer including computer hardware. Embodiments within the scope of the present invention may also include physical and other computer readable media for carrying or storing computer-executable instructions and/or data structures. Such computer readable media can be any media accessible by a general purpose or special purpose computer system. Computer readable media that store computer-executable instructions are physical storage media. Computer readable media that carry computer-executable instructions are transmission media. Thus, by way of example and not limitation, embodiments of the invention can comprise at least two distinct kinds of computer readable media: physical computer readable storage media and transmission computer readable media.

Although the present embodiments described herein are with reference to specific example embodiments it will be evident that various modifications and changes may be made to these embodiments without departing from the broader spirit and scope of the various embodiments. For example, hardware circuitry (e.g., Complementary Metal Oxide Semiconductor (CMOS) based logic circuitry), firmware, software (e.g., embodied in a non-transitory machine-readable medium), or any combination of hardware, firmware, and software may enable and operate the various devices, units, and modules described herein. For example, transistors, logic gates, and electrical circuits (e.g., Application Specific Integrated Circuit (ASIC) and/or Digital Signal Processor (DSP) circuit) may embody the various electrical structures and methods.

In addition, a non-transitory machine-readable medium and/or a system may embody the various operations, processes, and methods disclosed herein. Accordingly, the specification and drawings are illustrative rather than restrictive.

Physical computer readable storage media includes RAM, ROM, EEPROM, CD-ROM or other optical disk storage (such as CDs, DVDs, etc.), magnetic disk storage or other magnetic storage devices, solid-state disks or any other medium. They store desired program code in the form of computer-executable instructions or data structures which can be accessed by a general purpose or special purpose computer.

As used herein, the term “network” refers to one or more data links that enable the transport of electronic data between computer systems and/or modules and/or other electronic devices. When a network or another communications connection (either hardwired, wireless, or a combination of hardwired or wireless) transfers or provides information to a computer, the computer properly views the connection as a transmission medium. A general purpose or special purpose computer access transmission media that can include a network and/or data links which carry desired program code in the form of computer-executable instructions or data structures. The scope of computer readable media includes combinations of the above, that enable the transport of electronic data between computer systems and/or modules and/or other electronic devices. Further, upon reaching various computer system components, program code in the form of computer-executable instructions or data structures can be transferred automatically from transmission computer readable media to physical computer readable storage media (or vice versa). For example, computer-executable instructions or data structures received over a network or data link can be buffered in RAM within a Network Interface Controller (NIC), and then eventually transferred to computer system RAM and/or to less volatile computer readable physical storage media at a computer system. Thus, computer system components that also (or even primarily) utilize transmission media may include computer readable physical storage media.

Computer-executable instructions comprise, for example, instructions and data which cause a general purpose computer, special purpose computer, or special purpose processing device to perform a certain function or group of functions. The computer-executable instructions may be, for example, binary, intermediate format instructions such as assembly language, or even source code. Although the subject matter herein described is in a language specific to structural features and/or methodological acts, the described features or acts described do not limit the subject matter defined in the claims. Rather, the herein described features and acts are example forms of implementing the claims.

While this specification contains many specifics, these do not construe as limitations on the scope of the disclosure or of the claims, but as descriptions of features specific to particular implementations. A single implementation may implement certain features described in this specification in the context of separate implementations. Conversely, multiple implementations separately or in any suitable sub-combination may implement various features described herein in the context of a single implementation. Moreover, although features described herein as acting in certain combinations and even initially claimed as such, one or more features from a claimed combination may in some cases be excised from the combination, and the claimed combination may be directed to a sub-combination or variation of a sub-combination.

Similarly, while operations depicted herein in the drawings in a particular order to achieve desired results, this should not be understood as requiring that such operations be performed in the particular order shown or in sequential order or that all illustrated operations be performed, to achieve desirable results. In certain circumstances, multitasking and parallel processing may be advantageous. Moreover, the separation of various system components in the implementations should not be understood as requiring such separation in all implementations, and it should be understood that the described program components and systems may be integrated together in a single software product or packaged into multiple software products.

Even though particular combinations of features are recited in the claims and/or disclosed in the specification, these combinations are not intended to limit the disclosure of possible implementations. Other implementations are within the scope of the claims. For example, the actions recited in the claims may be performed in a different order and still achieve desirable results. In fact, many of these features may be combined in ways not specifically recited in the claims and/or disclosed in the specification. Although each dependent claim may directly depend on only one claim, the disclosure of possible implementations includes each dependent claim in combination with every other claim in the claim set.

Further, a computer system including one or more processors and computer readable media such as computer memory may practice the methods. In particular, one or more processors execute computer-executable instructions, stored in the computer memory, to perform various functions such as the acts recited in the embodiments.

Those skilled in the art will appreciate that the invention may be practiced in network computing environments with many types of computer system configurations including personal computers, desktop computers, laptop computers, message processors, hand-held devices, multi-processor systems, microprocessor-based or programmable consumer electronics, network PCs, minicomputers, mainframe computers, mobile telephones, PDAs, pagers, routers, switches, etc. Distributed system environments where local and remote computer systems, which are linked (either by hardwired data links, wireless data links, or by a combination of hardwired and wireless data links) through a network, both perform tasks may also practice the invention. In a distributed system environment, program modules may be located in both local and remote memory storage devices.

The following terms and phrases, unless otherwise indicated, shall have the following meanings.

As used herein, the term “connection request” refers to a process where a device or system initiates a communication link with another device or system. In the context of vehicle information systems, the connection request is made when a responder device, such as a smartphone or tablet, seeks to establish a link with the vehicle's information system. This request typically includes authentication details and a request to access specific vehicle data. The system receiving the request verifies the credentials and establishes a secure connection if the request is authorized, allowing data exchange to occur.

As used herein, the term “secure connection” refers to a method of communication that ensures the confidentiality, integrity, and authenticity of data exchanged between devices. It employs technologies and protocols to protect data from unauthorized access or tampering during transmission and to verify the identities of the communicating parties. Secure connections typically use encryption, authentication, and integrity-check mechanisms to safeguard the data and ensure that the communication is private and trustworthy.

As used herein, the term “request” refers to a formal request made to obtain current and specific details about the condition or operational state of a vehicle. This request can be initiated by an authorized party, such as a responder, and seeks to retrieve various types of data related to the vehicle's performance, location, or other relevant metrics.

As used herein, the term “responder” refers to an individual or entity that is authorized to access or interact with a system to retrieve information or take actions based on specific needs or circumstances. In the context of vehicle information systems, a responder may be a police officer, emergency services personnel, mechanic, or any other authorized party who requires access to status information for operational purposes.

As used herein, the term “responder device” refers to a device that is a tool used by authorized individuals, such as emergency responders or service personnel, to interact with the system and request vehicle information. The responder device may be a smartphone, tablet, or computer equipped with the necessary software to communicate with the vehicle and receive data.

As used herein, the term “authorization level” refers to the specific degree of access or permissions granted to a user or responder within a system. This level determines which data or functions the user can access or interact with based on their role, credentials, or predefined criteria. Authorization levels are used to enforce security and control access to sensitive or critical information, ensuring that individuals or entities can only access the information or perform actions appropriate to their role or responsibilities.

As used herein, the term “authentication code” refers to a unique alphanumeric sequence used to verify the identity of a responder device. The authentication code ensures that only authorized devices can access specific vehicle information, providing a layer of security to prevent unauthorized access.

As used herein, the term “QR Code scanning” refers to the process of using a device, such as a smartphone or tablet, equipped with a camera and QR code scanning software to read and interpret Quick Response (QR) codes. QR codes are two-dimensional barcodes that encode information in a matrix of black and white squares. When scanned, the QR code can quickly provide access to various types of information, such as Uniform Resource Locators (URLs), contact details, or product data.

As used herein, the term “Near Field Communication (NFC) tag scanning” refers to the use of a device equipped with NFC technology to read data from an NFC tag. NFC is a short-range wireless communication technology that allows devices to exchange data when placed within close proximity, typically a few centimeters. NFC tags are small, passive devices that store information and can be read by an NFC-enabled device to retrieve data such as URLs, contact information, or product details.

As used herein, the term “application associated with the responder device” refers to an application software that is installed on a responder's device, such as a smartphone, tablet, or other electronic devices used by first responders or authorities. This application is designed to interact with external systems, such as a vehicle information management system, to request and retrieve data. It facilitates communication between the responder's device and the system by sending requests for specific information, processing authentication codes, and displaying the retrieved data to the responder.

As used herein, the term “bar code scanning” refers to the use of a device equipped with a bar code reader or scanner to read and interpret one-dimensional bar codes. Bar codes are visual representations of data in the form of parallel lines and spaces of varying widths. The scanner decodes the pattern of lines and spaces to extract the encoded information, which can include product IDs, prices, or other data relevant to inventory management and sales.

As used herein, the term “Radio Frequency Identification (RFID) Tag scanning” refers to the use of a device with RFID technology to read data from RFID tags. RFID involves the use of radio waves to transfer data between an RFID reader and an RFID tag. RFID tags can be passive (without a power source) or active (with a power source) and store information such as identification numbers, product details, or access credentials.

As used herein, the term “responder profile” refers to a comprehensive data set associated with individuals who are authorized to access and interact with vehicle information under various circumstances. The responder profile comprises essential personal identification details such as the responder's employee ID, full name, and contact information, including phone number and email address. The responder profile comprises personal identification information, authentication information, role information, and authorization information.

As used herein, the term “identity information” refers to the specific data used to uniquely identify an individual or entity within a system. For a responder, this might include personal details such as name, contact information, job title, or credentials.

As used herein, the term “role” refers to the specific function or responsibility assigned to the individual or entity within the context of the system. The role determines the scope of access and actions that are permitted to be performed.

As used herein, the term “employee ID” refers to a unique identifier assigned to an individual within an organization. The employee ID is used for tracking and managing employee records, such as attendance, performance, and access to resources. This ID helps to distinguish between employees and streamline administrative processes.

As used herein, the term “name” refers to the personal identifier of an individual, typically consisting of a first name, middle name, and last name. It is used to distinguish and address individuals within various contexts, including professional, social, and legal settings.

As used herein, the term “biometric data” refers to unique physical or behavioral characteristics of an individual used for identification and authentication purposes. Examples include fingerprints, facial recognition, iris scans, and voice patterns. This data is used to verify identity and enhance security by providing a personal and difficult-to-replicate means of authentication.

As used herein, the term “authentication token” refers to a security feature used to verify the identity of a user or device. The authentication token is typically a string of characters, or a digital object issued after a successful login or authentication process. The token is used in subsequent interactions to grant access to resources or services, ensuring that only authorized users can perform certain actions.

As used herein, the term “personal identification information” refers to the specific details used to uniquely identify and contact an individual within an organization. The personal identification information includes the Employee ID, Name, and Contact Information.

As used herein, the term “authentication information” refers to the details and methods used to verify an identity. The authentication information includes biometric data, authentication tokens, and user credentials.

As used herein, the term “role information” refers to the specifics of an individual's position within an organization. It includes job title, department, and hierarchical level.

As used herein, the term “authorization information” refers to the permissions and access rights granted to an individual. The authorization information includes access level, assigned duties, and specific permissions.

As used herein, the term “user credentials” refers to a combination of information, such as a username and password, used to authenticate and verify the identity of a user seeking access to a system or data.

As used herein, the term “contact information” refers to the details used to communicate with an individual or organization, typically including a phone number, email address, and physical address. This information is essential for reaching out, coordinating, and exchanging messages.

As used herein, the term “government-issued ID” refers to an identification document provided by a government authority, which serves as an official proof of identity. Examples include driver's licenses, passports, national identity cards, and social security cards. These IDs are used for verifying identity in legal, administrative, and various official contexts.

As used herein, the term “job title” refers to the official designation or label given to a role within an organization that reflects the position's primary responsibilities and functions. It helps to identify the employee's role and often provides insight into their level of authority and expertise within the organization.

As used herein, the term “access level” refers to the degree of access or permissions granted to an individual within a system or organization. It determines what information, systems, or resources the individual can view, modify, or manage, based on their role and responsibilities.

As used herein, the term “assigned duties” refers to the specific tasks or responsibilities that an individual is expected to perform as part of their role. These duties are typically outlined in job descriptions and are crucial for achieving organizational goals and ensuring effective operation.

As used herein, the term “hierarchical level” refers to the rank or position of an individual within the organizational structure. It reflects the level of authority, responsibility, and decision-making power the individual holds relative to others in the organization. This level helps to determine reporting relationships and the scope of influence within the organization.

As used herein, the term “Time-Based One-Time Password (TOTP)” refers to a type of authentication code used to verify the identity of a user. The TOTP is generated using a combination of a secret key and the current time. The TOTP algorithm creates a unique, temporary password that changes at regular intervals, typically every 30 seconds.

As used herein, the term “secret key” refers to a unique, confidential key shared between the user and the authentication system. This key is used as the basis for generating the TOTP codes and must be kept secure.

As used herein, the term “synchronized clocks” refers to the alignment of the time on the user's device and the server that generates the TOTP codes. Both the device and the server must have their clocks accurately synchronized to the same time standard, such as Coordinated Universal Time (UTC).

As used herein, the term “fingerprint” refers to the unique pattern of ridges and valleys found on the surface of an individual's fingertips. Fingerprints are highly distinct and are used in biometric systems to verify identity. The process involves capturing an image of the fingerprint and comparing it against stored fingerprint data to confirm the individual's identity.

As used herein, the term “iris scan” refers to the process of capturing and analyzing the unique patterns found in the colored part of the eye, known as the iris. Each iris has a distinct pattern that remains relatively stable throughout a person's life. An iris scan involves using a specialized camera to capture a detailed image of the iris, which is then compared with stored iris data to authenticate the individual.

As used herein, the term “cryptographic hash” refers to a function that converts input data into a fixed-size string of characters, which appears random. This hash is created using a cryptographic algorithm, ensuring that even minor changes in the input data result in a significantly different hash value. Cryptographic hashes are designed to be secure against reverse engineering and collision attacks.

As used herein, the term “regular intervals” refers to the periodic updating of the authentication code according to a fixed schedule or timeframe, such as every few seconds or minutes.

As used herein, the term “invalidate” refers to making something no longer valid or effective. In the context of security and authentication, invalidating an authentication code, token, or credential means rendering it unusable for further access or operations. Once invalidated, the code or credential can no longer be used to authenticate or authorize access to systems, data, or services, ensuring that it cannot be reused or compromised.

As used herein, the term “Vehicle Identification Number (VIN)” refers to a unique 17-character alphanumeric code assigned to every vehicle. It serves as a fingerprint for the vehicle, providing specific information about its manufacturer, model, and year of production.

As used herein, the term “make and model” refers to the manufacturer of the vehicle (e.g., Ford, Toyota), while the model denotes the specific product or version produced by that manufacturer (e.g., Mustang, Camry).

As used herein, the term “year of manufacture” refers to the calendar year in which the vehicle is produced or assembled. This information helps determine the vehicle's age and compliance with safety and environmental standards.

As used herein, the term “license plate number” refers to a unique combination of letters and numbers displayed on a vehicle's license plate, used for identification and registration purposes by authorities.

As used herein, the term “registration status” refers to whether the vehicle is currently registered with the appropriate government authorities and in compliance with legal requirements.

As used herein, the term “owner's name” refers to the full name of the individual or entity who legally owns the vehicle. This information is used to identify the registered owner.

As used herein, the term “owner's address” refers to the residential or mailing address of the vehicle owner, used for correspondence and legal notifications.

As used herein, the term “owner's contact details” refers to the information used to reach the owner of a vehicle or property. The owner's contact details include phone number, email address and email address.

As used herein, the term “insurance details” refers to information about the vehicle's insurance policy, including the insurer's name, policy number, coverage details, and validity period.

As used herein, the term “current location” refers to the real-time geographical position of the vehicle, often obtained via GPS technology. This information is used for tracking and navigation purposes.

As used herein, the term “speed” refers to the current velocity at which the vehicle is traveling, typically measured in miles per hour (mph) or kilometers per hour (km/h).

As used herein, the term “fuel level” refers to the amount of fuel remaining in the vehicle's tank, indicating how much longer the vehicle can operate before needing a refuel.

As used herein, the term “mileage” refers to the total distance the vehicle has travelled, usually measured in miles or kilometers. It reflects the vehicle's usage and wear.

As used herein, the term “maintenance history of the vehicle” refers to records of all maintenance activities performed on the vehicle, including routine service, repairs, and parts replacements.

As used herein, the term “accident history” refers to information about past accidents involving the vehicle, including dates, damages, and any insurance claims or legal actions resulting from these incidents.

As used herein, the term “service history” refers to a record of all service events performed on the vehicle, such as oil changes, tire rotations, and other scheduled maintenance.

As used herein, the term “damage reports” refers to documentation detailing any physical damage sustained by the vehicle, including the extent of damage and repairs conducted.

As used herein, the term “traffic penalty information” refers to details of any traffic violations or fines incurred by the vehicle, including the nature of the offense and the penalties imposed.

As used herein, the term “recent incident information” refers to information about recent events or incidents involving the vehicle, such as breakdowns, accidents, or other notable occurrences.

As used herein, the term “occupant information” refers to details about the individuals currently in the vehicle, including their names and roles, if applicable. This may be used for safety or emergency purposes.

As used herein, the term “historical incident information” refers to records of past incidents involving the vehicle, such as previous accidents or notable events that may affect its history.

As used herein, the term “insurance claims” refers to records of claims made under the vehicle's insurance policy, including details of the claims, the amount claimed, and the outcomes.

As used herein, the term “recall information” refers to information about any manufacturer recalls affecting the vehicle, including reasons for the recall and the steps taken to address any issues.

As used herein, the term “legal and compliance records” refers to documentation related to legal and regulatory compliance concerning the vehicle, including registrations, inspections, and any legal disputes.

As used herein, the term “customization history” refers to the comprehensive record of modifications and adjustments made to a vehicle or system to tailor it to specific needs or preferences. The customization history comprises information of all alterations, upgrades, repairs, and parts replacements carried out over time.

As used herein, the term “segments” refers to a distinct portion or subset of data that is categorized based on specific criteria or attributes. In data management, a segment represents a group of related information that is organized to facilitate analysis, retrieval, or processing. Each segment typically includes a particular type of data or category, enabling efficient handling and interpretation of the information.

As used herein, the term “segment of vehicle information” refers to a specific subset or category of data related to a vehicle, organized based on certain attributes or criteria. It may include various types of information such as basic vehicle details, owner information, insurance details, or maintenance records. Each segment contains relevant data that is grouped together for efficient access, management, and analysis. The selection of a segment depends on factors such as the type of information required and the authorization level of the responder accessing the data.

As used herein, the term “general information segment” refers to a category of vehicle data that includes fundamental details about the vehicle, such as its make and model, year of manufacture, VIN, and registration status.

As used herein, the term “owner information segment” refers to a segment that contains personal details about the vehicle's owner, including their name, address, and contact information.

As used herein, the term “operational data segment” refers to a subset of vehicle data related to the vehicle's current performance and operational status, such as speed, fuel level, mileage, and current location.

As used herein, the term “case history data segment” refers to a subset of vehicle data related to historical records and data related to the vehicle, such as past incidents, insurance claims, recall information, and legal and compliance records.

As used herein, the term “incident-specific data segment” refers to a subset of vehicle data related to specific incidents involving the vehicle, including accident history, recent incident details, damage reports, and service records.

As used herein, the term “vehicle information accessible level” refers to the degree or extent of vehicle-related data that can be accessed by a responder, determined by their authorization level. Each segment of vehicle information such as general information, owner information, operational data, case history, traffic penalty data, and incident-specific data can have various levels of accessibility. These levels dictate which segments and specific details within those segments the responder is permitted to view or retrieve based on their assigned authorization level.

As used herein, the term “real-time updates” refers to a process of continuously or periodically adjusting the access permissions of a responder based on their current authorization status. This involves dynamically modifying the responder's access rights to vehicle information in real-time, ensuring that the data they can view or interact with is aligned with their current authorization level.

As used herein, the term “proximity” refers to a physical distance or nearness between the responder's device (such as a mobile phone, tablet, or other electronic device) and the vehicle. This proximity measurement is used to determine if the responder's device is within a specified range to establish a connection or access vehicle information. Proximity can be detected using technologies like Bluetooth, Near Field Communication (NFC), or GPS, and is crucial for ensuring secure and contextually appropriate access to vehicle data based on the responder's closeness to the vehicle.

As used herein, the term “urgency of a situation” refers to a level of immediacy or criticality associated with an event or condition that requires prompt attention or action. In the context of vehicle information systems, urgency refers to the degree to which a situation within or involving the vehicle necessitates immediate response or access to specific data. This urgency can be determined based on various factors, such as the severity of an incident, real-time data from sensors (e.g., collision impact, sudden braking), or other indicators that suggest the need for expedited intervention or information retrieval.

As used herein, the term “historical access patterns” refers to records or data reflecting the previous instances and behaviors of how and when a responder accessed status information. This includes the frequency, timing, duration, and context of past access sessions.

As used herein, the term “sensitivity score” refers to a numerical or categorical value assigned to a responder indicating their level of access or the sensitivity of the information they can access. The sensitivity score reflects the degree of trust or risk associated with the responder's access, based on various factors such as their historical behavior and interactions with the system.

As used herein, the term “frequency of historical access sessions” refers to a number of times a responder has accessed the status information over a specified period. This measure helps assess how often the responder interacts with the system.

As used herein, the term “duration of historical access sessions” refers to a length of time each access session lasted. This measure indicates how long the responder engages with the status information during each session.

As used herein, the term “behavioral analysis of responder's interactions” refers to a process of evaluating and interpreting the responder's actions and patterns while interacting with the system. This analysis comprises examining how the responder navigates the system, which information they access, and any anomalies or trends in their usage behavior.

As used herein, the term “recent vehicle activity” refers to information or data related to the vehicle's actions and status during a recent time frame. The recent vehicle activity comprises details about the vehicle's current or very recent operational state, such as recent trips, movements, speed changes, fuel consumption, or any other relevant events or conditions that have occurred shortly before the current time. This data is useful for understanding the vehicle's immediate past performance and status.

As used herein, the term “automatically” refers to a process by which the vehicle information accessible level in each segment is changed or updated without manual intervention, typically using predefined rules, algorithms, or real-time data inputs. This automatic adjustment ensures that access levels are dynamically managed based on the current context or conditions.

As used herein, the term “owner preference” refers to a process by which the vehicle information accessible level in each segment is modified according to the specific choices or settings established by the vehicle owner. This adjustment reflects the owner's personal preferences or requirements regarding who can access different segments of vehicle information and under what circumstances.

As used herein, the term “alert” refers to a notification or message sent to the vehicle owner or a designated administrator when a responder accesses the status information. This alert serves to inform them that an access event has occurred, ensuring that they are aware of and can monitor who is viewing or retrieving the vehicle data. The alert can be delivered via various methods such as email, SMS, or in-app notifications, depending on the system's capabilities and user preferences.

As used herein, the term “administrator” refers to a person or role designated with the authority and responsibility to manage and oversee the vehicle information system. The administrator typically has elevated access rights and control over system settings, user permissions, and data access policies. They may be responsible for configuring access levels, monitoring system activity, handling security issues, and ensuring the proper functioning of the system.

As used herein, the term “owner” refers to the individual or entity who holds legal ownership of the vehicle. The owner is responsible for the vehicle's registration, insurance, and maintenance. In the context of a vehicle information system, the owner has the authority to set preferences, manage access controls, and receive notifications related to the vehicle's status and information. The owner's permissions typically comprise controlling who can access different segments of vehicle data and making decisions about the vehicle's information management.

As used herein, the term “additional status information request” refers to a request made by a responder for more detailed or supplementary data about the vehicle beyond the initial information provided. This request may involve querying specific segments or categories of vehicle information, such as operational status, historical records, or maintenance details, that were not included in the initial access or query.

As used herein, the term “encrypt” refers to a process of converting status information into a secure, coded format to protect it from unauthorized access during transmission. Encryption uses algorithms to transform the data into a format that can only be read or understood by someone who has the appropriate decryption key or credentials.

As used herein, the term “decrypt” refers to a process of converting encrypted status information back into its original, readable format. Decryption is performed using a key or authentication token to reverse the encryption process, allowing authorized recipients, such as the responder device, to access and understand the transmitted data.

As used herein, the term “infotainment system” or “infotainment unit” or “in-vehicle infotainment system” (IVI) as used herein refers to a combination of systems which are used to deliver entertainment and information. In an example, the information may be delivered to the driver and the passengers of a vehicle through audio/video interfaces, control elements like touch screen displays, button panel, voice commands, and more. Some of the main components of an in-vehicle infotainment systems are integrated head-unit, heads-up display, high-end Digital Signal Processors (DSPs), and Graphics Processing Units (GPUs) to support multiple displays, operating systems, Controller Area Network (CAN), Low-Voltage Differential Signaling (LVDS), and other network protocol support (as per the requirement), connectivity modules, automotive sensors integration, digital instrument cluster, etc.

As used herein, the term “bidirectional communication” refers to an exchange of data between two components. In an example, the first component can be a vehicle and the second component can be an infrastructure that is enabled by a system of hardware, software, and firmware. This communication is typically wireless. In another example, the first component can be a charging system and the second component can be a charging station.

As used herein, the term “Data set” (or “Dataset”) is a collection of data. In the case of tabular data, a data set corresponds to one or more database tables, where every column of a table represents a particular variable, and each row corresponds to a given record of the data set in question. The data set lists values for each of the variables, such as height and weight of an object, for each member of the data set. Each value is known as a datum. Data sets can also consist of a collection of documents or files.

The term “vehicle” as used herein refers to a thing used for transporting people or goods. Automobiles, cars, trucks, buses, etc., are examples of vehicles.

As used herein, the term “vehicle computer system” refers to a system in automotive electronics that controls one or more of the electrical systems or subsystems in a vehicle. The computer executes a large number of different software functions in the powertrain, chassis, driver assistance, and infotainment domains, etc., that are executed on separate control units. The vehicle computer system may be communicatively coupled with an external device of a user.

As used herein “Machine learning” refers to algorithms that give a computer the ability to learn without explicit programming, including algorithms that learn from and make predictions about data. Machine learning techniques include, but are not limited to, support vector machine, artificial neural network (ANN) (also referred to herein as a “neural net”), deep learning neural network, logistic regression, discriminant analysis, random forest, linear regression, rules-based machine learning, Naive Bayes, nearest neighbor, decision tree, decision tree learning, and hidden Markov, etc. For the purposes of clarity, part of a machine learning process can use algorithms such as linear regression or logistic regression. However, using linear regression or another algorithm as part of a machine learning process is distinct from performing a statistical analysis such as regression with a spreadsheet program. The machine learning process can continually learn and adjust the classifier as new data becomes available and does not rely on explicit or rules-based programming. The ANN may be featured with a feedback loop to adjust the system output dynamically as it learns from the new data as it becomes available. In machine learning, backpropagation and feedback loops are used to train the Artificial Intelligence/Machine Learning (AI/ML) model improving the model's accuracy and performance over time. Statistical modeling relies on finding relationships between variables (e.g., mathematical equations) to predict an outcome.

As used herein, the term “communication” refers to the transmission of information and/or data from one point to another. Communication may be by means of electromagnetic waves. It is also a flow of information from one point, known as the source, to another, the receiver. Communication comprises one of the following: transmitting data, instructions, and information or a combination of data, instructions, and information. Communication happens between any two communication systems or communicating units. The term “in communication with” may refer to any coupling, connection, or interaction using electrical signals to exchange information or data, using any system, hardware, software, protocol, or format, regardless of whether the exchange occurs wirelessly or over a wired connection. The term “communication” includes systems that combine other more specific types of communication, such as V2I (Vehicle-to-Infrastructure), V2I (Vehicle-to-Infrastructure), V2N (Vehicle-to-Network), V2V (Vehicle-to-Vehicle), V2P (Vehicle-to-Pedestrian), V2D (Vehicle-to-Device) and V2G (Vehicle-to-Grid) and Vehicle-to-Everything (V2X) communication. V2X communication is the transmission of information from a vehicle to any entity that may affect the vehicle, and vice versa. The main motivations for developing V2X are occupant safety, road safety, traffic efficiency and energy efficiency. Depending on the underlying technology employed, there are two types of V2X communication technologies: cellular networks and other technologies that support direct device-to-device communication (such as Dedicated Short-Range Communication (DSRC), Port Community System (PCS), Bluetooth®, Wi-Fi®, etc.). Further, the emergency communication apparatus is configured on a computer with the communication function and is connected for bidirectional communication with the on-vehicle emergency report apparatus by a communication line through a radio station and a communication network such as a public telephone network or by satellite communication through a communication satellite. The emergency communication apparatus is adapted to communicate, through the communication network, with communication terminals including a road management office, a police station, a fire department, and a hospital. The emergency communication apparatus can also be connected online with the communication terminals of the persons or vehicles concerned, associated with the occupant or vehicle, and the driver or vehicle receiving the service of the emergency-reporting vehicle.

The terms “non-transitory computer readable medium” and “computer readable medium” include a single medium or multiple media such as a centralized or distributed database, and/or associated caches and servers that store one or more sets of instructions. Further, the terms “non-transitory computer readable medium” and “computer readable medium” include any tangible medium that is capable of storing, encoding, or carrying a set of instructions for execution by a processor that, for example, when executed, cause a system to perform any one or more of the methods or operations disclosed herein. As used herein, the term “computer readable medium” is expressly defined to include any type of computer readable storage device and/or storage disk and to exclude propagating signals.

The term, “handshaking” refers to an exchange of predetermined signals between agents connected by a communications channel to assure each that it is connected to the other (and not to an imposter). This may also include the use of passwords and codes by an operator. Handshaking signals are transmitted back and forth over a communications network to establish a valid connection between two stations. A hardware handshake uses dedicated wires such as the request-to-send (RTS) and clear-to-send (CTS) lines in an RS-232 serial transmission. A software handshake sends codes such as “synchronize” (SYN) and “acknowledge” (ACK) in a TCP/IP transmission.

The term “in communication with” as used herein, refers to any coupling, connection, or interaction using electrical signals to exchange information or data, using any system, hardware, software, protocol, or format, regardless of whether the exchange occurs wirelessly or over a wired connection.

As used herein, the term “network” may include the Internet, a local area network, a wide area network, or combinations thereof. The network may include one or more networks or communication systems, such as the Internet, the telephone system, satellite networks, cable television networks, and various other private and public networks. In addition, the connections may include wired connections (such as wires, cables, fiber optic lines, etc.), wireless connections, or combinations thereof. Furthermore, although not shown, other computers, systems, devices, and networks may also be connected to the network. Network refers to any set of devices or subsystems connected by links joining (directly or indirectly) a set of terminal nodes sharing resources located on or provided by network nodes. The computers use common communication protocols over digital interconnections to communicate with each other. For example, subsystems may comprise the cloud. Cloud refers to servers that are accessed over the Internet, and the software and databases that run on those servers.

The embodiments described herein can be directed to one or more of a system, a method, an apparatus, and/or a computer program product at any possible technical detail level of integration. The computer program product can include a computer readable storage medium (or media) having computer readable program instructions thereon for causing a processor to carry out aspects of the one or more embodiments described herein. The computer readable storage medium can be a tangible device that can retain and store instructions for use by an instruction execution device. For example, the computer readable storage medium can be, but is not limited to, an electronic storage device, a magnetic storage device, an optical storage device, an electromagnetic storage device, a superconducting storage device, and/or any suitable combination of the foregoing. A non-exhaustive list of more specific examples of the computer readable storage medium can also include the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon and/or any suitable combination of the foregoing. A computer readable storage medium, as used herein, does not construe transitory signals per se, such as radio waves and/or other freely propagating electromagnetic waves, electromagnetic waves propagating through a waveguide and/or other transmission media (e.g., light pulses passing through a fiber-optic cable), and/or electrical signals transmitted through a wire.

Computer readable program instructions described herein are downloadable to respective computing/processing devices from a computer readable storage medium and/or to an external computer or external storage device via a network, for example, the Internet, a local area network, a wide area network and/or a wireless network. The network can comprise copper transmission cables, optical transmission fibers, wireless transmission, routers, firewalls, switches, gateway computers, and/or edge servers. A network adapter card or network interface in each computing/processing device receives computer readable program instructions from the network and forwards the computer readable program instructions for storage in a computer readable storage medium within the respective computing/processing device. Computer readable program instructions for carrying out operations of the one or more embodiments described herein can be assembler instructions, instruction-set-architecture (ISA) instructions, machine instructions, machine dependent instructions, microcode, firmware instructions, state-setting data, configuration data for integrated circuitry, and/or source code and/or object code written in any combination of one or more programming languages, including an object oriented programming language such as Smalltalk, C++ or the like, and/or procedural programming languages, such as the “C” programming language and/or similar programming languages. The computer readable program instructions can execute entirely on a computer, partly on a computer, as a stand-alone software package, partly on a computer and/or partly on a remote computer or entirely on the remote computer and/or server. In the latter scenario, the remote computer can be connected to a computer through any type of network, including a local area network (LAN) and/or a wide area network (WAN), and/or the connection can be made to an external computer (for example, through the Internet using an Internet Service Provider). In one or more embodiments, electronic circuitry including, for example, programmable logic circuitry, field-programmable gate arrays (FPGA), and/or programmable logic arrays (PLA) can execute the computer readable program instructions by utilizing state information of the computer readable program instructions to personalize the electronic circuitry, in order to perform aspects of the one or more embodiments described herein.

Aspects of the one or more embodiments described herein are described with reference to flowchart illustrations and/or block diagrams of methods, apparatus (systems), and computer program products according to one or more embodiments described herein. Each block of the flowchart illustrations and/or block diagrams, and combinations of blocks in the flowchart illustrations and/or block diagrams, can be implemented by computer readable program instructions. These computer readable program instructions can be provided to a processor of a general purpose computer, special purpose computer and/or other programmable data processing apparatus to produce a machine, such that the instructions, which execute via the processor of the computer or other programmable data processing apparatus, can create means for implementing the functions/acts specified in the flowchart and/or block diagram block or blocks. These computer readable program instructions can also be stored in a computer readable storage medium that can direct a computer, a programmable data processing apparatus and/or other devices to function in a particular manner, such that the computer readable storage medium having instructions stored therein can comprise an article of manufacture including instructions which can implement aspects of the function/act specified in the flowchart and/or block diagram block or blocks. The computer readable program instructions can also be loaded onto a computer, other programmable data processing apparatus and/or other device to cause a series of operational acts to be performed on the computer, other programmable apparatus and/or other device to produce a computer implemented process, such that the instructions which execute on the computer, other programmable apparatus and/or other device implement the functions/acts specified in the flowchart and/or block diagram block or blocks.

The flowcharts and block diagrams in the figures illustrate the architecture, functionality and/or operation of possible implementations of systems, computer-implementable methods and/or computer program products according to one or more embodiments described herein. In this regard, each block in the flowchart or block diagrams can represent a module, segment and/or portion of instructions, which comprises one or more executable instructions for implementing the specified logical function(s). In one or more alternative implementations, the functions noted in the blocks can occur out of the order noted in the Figures. For example, two blocks shown in succession can be executed substantially concurrently, and/or the blocks can sometimes be executed in the reverse order, depending upon the functionality involved. It will also be noted that each block of the block diagrams and/or flowchart illustration, and/or combinations of blocks in the block diagrams and/or flowchart illustration, can be implemented by special purpose hardware-based systems that can perform the specified functions and/or acts and/or carry out one or more combinations of special purpose hardware and/or computer instructions.

While the subject matter described herein is in the general context of computer-executable instructions of a computer program product that runs on a computer and/or computers, those skilled in the art will recognize that the one or more embodiments herein also can be implemented in combination with one or more other program modules. Program modules include routines, programs, components, data structures, and/or the like that perform particular tasks and/or implement particular abstract data types. Moreover, other computer system configurations, including single-processor and/or multiprocessor computer systems, mini-computing devices, mainframe computers, as well as computers, hand-held computing devices (e.g., PDA, phone), microprocessor-based or programmable consumer and/or industrial electronics and/or the like can practice the herein described computer-implemented methods. Distributed computing environments, in which remote processing devices linked through a communications network perform tasks, can also practice the illustrated aspects. However, stand-alone computers can practice one or more, if not all, aspects of the one or more embodiments described herein. In a distributed computing environment, program modules can be located in both local and remote memory storage devices.

As used in this application, the terms “component,” “system,” “platform,” “interface,” and/or the like, can refer to and/or can include a computer-related entity or an entity related to an operational machine with one or more specific functionalities. The entities described herein can be either hardware, a combination of hardware and software, software, or software in execution. For example, a component can be, but is not limited to being, a process running on a processor, a processor, an object, an executable, a thread of execution, a program and/or a computer. By way of illustration, both an application running on a server and the server can be a component. One or more components can reside within a process and/or thread of execution and a component can be localized on one computer and/or distributed between two or more computers. In another example, respective components can execute from various computer readable media having various data structures stored thereon. The components can communicate via local and/or remote processes such as in accordance with a signal having one or more data packets (e.g., data from one component interacting with another component in a local system, distributed system and/or across a network such as the Internet with other systems via the signal). As another example, a component can be an apparatus with specific functionality provided by mechanical parts operated by electric or electronic circuitry, which is operated by a software and/or firmware application executed by a processor. In such a case, the processor can be internal and/or external to the apparatus and can execute at least a part of the software and/or firmware application. As yet another example, a component can be an apparatus that provides specific functionality through electronic components without mechanical parts, where the electronic components can include a processor and/or other means to execute software and/or firmware that confers at least in part the functionality of the electronic components. In an aspect, a component can emulate an electronic component via a virtual machine, e.g., within a cloud computing system.

As it is employed in the subject specification, the term “processor” can refer to any computing processing unit and/or device comprising, but not limited to, single-core processors; single-processors with software multi-thread execution capability; multi-core processors; multi-core processors with software multi-thread execution capability; multi-core processors with hardware multi-thread technology; parallel platforms; and/or parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components, and/or any combination thereof designed to perform the functions described herein. Further, processors can exploit nano-scale architectures such as, but not limited to, molecular based transistors, switches and/or gates, in order to optimize space usage and/or to enhance performance of related equipment. A combination of computing processing units can implement a processor.

Herein, terms such as “store,” “storage,” “data store,” data storage,” “database,” and any other information storage component relevant to operation and functionality of a component refer to “memory components,” entities embodied in a “memory,” or components comprising a memory. Memory and/or memory components described herein can be either volatile memory or nonvolatile memory or can include both volatile and nonvolatile memory. By way of illustration, and not limitation, nonvolatile memory can include read only memory (ROM), programmable ROM (PROM), electrically programmable ROM (EPROM), electrically erasable ROM (EEPROM), flash memory, and/or nonvolatile random access memory (RAM) (e.g., ferroelectric RAM (FeRAM). Volatile memory can include RAM, which can function as external cache memory, for example. By way of illustration and not limitation, RAM can be available in many forms such as synchronous RAM (SRAM), dynamic RAM (DRAM), synchronous DRAM (SDRAM), double data rate SDRAM (DDR SDRAM), enhanced SDRAM (ESDRAM), Synch link DRAM (SLDRAM), direct Rambus RAM (DRRAM), direct Rambus dynamic RAM (DRDRAM) and/or Rambus dynamic RAM (RDRAM). Additionally, the described memory components of systems and/or computer-implemented methods herein include, without being limited to including, these and/or any other suitable types of memory.

The embodiments described herein include mere examples of systems and computer-implemented methods. It is, of course, not possible to describe every conceivable combination of components and/or computer-implemented methods for purposes of describing the one or more embodiments, but one of ordinary skill in the art can recognize that many further combinations and/or permutations of the one or more embodiments are possible. Furthermore, to the extent that the terms “includes,” “has,” “possesses,” and the like are used in the detailed description, claims, appendices and/or drawings such terms are intended to be inclusive in a manner similar to the term “comprising” as “comprising” is interpreted when employed as a transitional word in a claim.

The descriptions of the one or more embodiments are for purposes of illustration but are not exhaustive or limiting to the embodiments described herein. Many modifications and variations will be apparent to those of ordinary skill in the art without departing from the scope and spirit of the described embodiments. The terminology used herein best explains the principles of the embodiments, the practical application and/or technical improvement over technologies found in the marketplace, and/or to enable others of ordinary skill in the art to understand the embodiments described herein.

Business problem: Police and other responders face significant challenges in efficiently accessing detailed vehicle information during traffic stops or incidents. The current process often relies on drivers to provide this information, which can be time-consuming and prone to inaccuracies. Without quick access to vital data such as vehicle ownership, maintenance history, accident records, and legal compliance documents, the ability to make informed decisions is hindered. This results in delays, increased operational costs, and potential risks to public safety and trust.

Business solution: The present system enhances operational efficiency by automating and securing the process of accessing vehicle information for responders. When a responder device requests information, the system validates the authentication code to establish a secure connection. The present system then retrieves real-time vehicle data, such as ownership details, maintenance history, and legal compliance, based on the responder's authorization level. The integration of a machine learning model further optimizes data retrieval and categorization according to the responder's access rights. The present system reduces delays and inaccuracies and lowers operational costs by eliminating the need for manual data collection. As a result, the present system improves decision-making and public safety, ensuring that responders have timely and accurate vehicle information when needed.

Technical problem: Current vehicle information systems face challenges in efficiently managing data access when responders are involved. The systems rely on drivers to provide necessary vehicle details, which can lead to delays and inaccuracies. When a responder needs to access comprehensive vehicle data such as ownership, maintenance history, and legal compliance, the system's reliance on manual input creates inefficiencies. Additionally, existing systems lack a standardized approach to validating responder credentials and managing real-time data requests, making it difficult to ensure timely and accurate information retrieval. This results in operational inefficiencies and potential delays in critical decision-making.

Technical Solution: The present system addresses the technical challenges of managing vehicle information by automating and securing data access for responders. The system validates responder credentials and establishes a secure connection upon receiving a request. The present system retrieves real-time status information based on the responder's authorization level. The integration of a machine learning model optimizes data retrieval and categorization, ensuring that the information is both accurate and relevant. The present system eliminates the need for manual input from drivers, reduces delays and inaccuracies, and enhances the efficiency of information management. By automating these processes, the system ensures timely and reliable access to critical vehicle data, improving operational effectiveness and decision-making.

Technical Result: The present system automates and secures the access to vehicle information for responders, enhancing the efficiency of data retrieval and categorization according to each responder's authorization level. By enabling real-time data access, the system significantly mitigates delays and inaccuracies that often arise from manual data collection. Integration with machine learning algorithms ensures the accuracy and relevance of the vehicle information, thereby improving the effectiveness and responsiveness of the information management process. The present system supports various authorities and users by providing access to vehicle information based on their specific needs. For example, law enforcement officers benefit from detailed vehicle data and recent incident reports, which aids in effective investigation and response during emergencies. Emergency units can access crucial passenger information, including medical details and emergency contacts, facilitating a prompt and informed response in critical situations. Vehicle mechanics can obtain comprehensive information about the vehicle's status, maintenance history, and condition, which supports precise diagnostics and efficient repairs. Furthermore, the system allows parents to monitor their child's driving behavior and vehicle usage, promoting safe driving practices and providing necessary guidance. This targeted access ensures that each authority or user receives the relevant information needed to perform their duties efficiently and effectively. The automation of data access and retrieval not only reduces operational costs but also minimizes errors, ensuring timely and reliable access to crucial vehicle information.

### Technical Details Specific to Technical Result

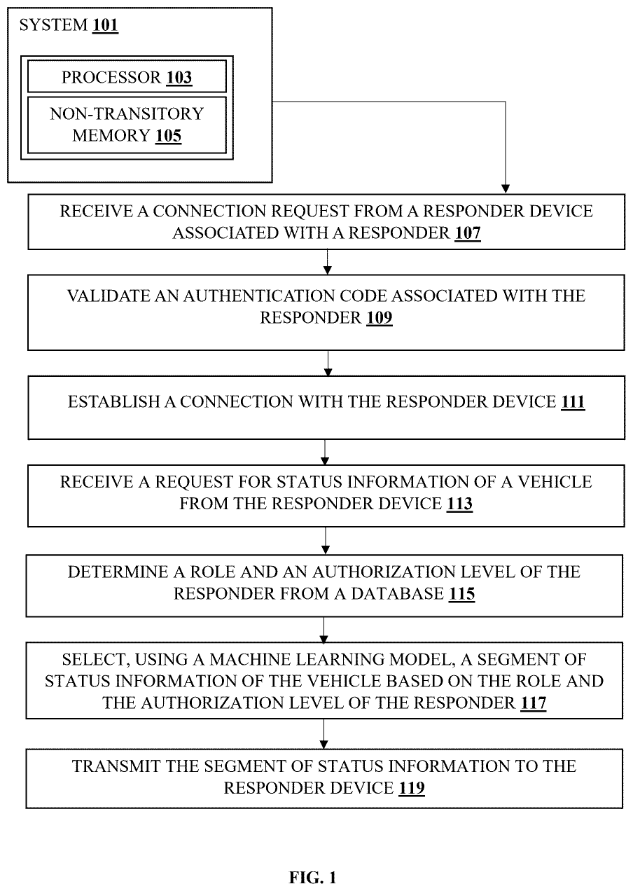

In an aspect, a system is described. As an example, FIG. 1 illustrates a system, according to one or more embodiments. The system 101 comprises: a processor 103 storing instructions in non-transitory memory 105. The processor 103 is operable to: receive a connection request from a responder device associated with a responder (at step 107); validate an authentication code associated with the responder (at step 109); establish a connection with the responder device (at step 111); receive a request for status information of a vehicle from the responder device (at step 113); determine a role and an authorization level of the responder from a database (at step 115); select, using a machine learning model, a segment of status information of the vehicle based on the role and the authorization level of the responder (at step 117); and transmit the segment of status information to the responder device (at step 119).

In one embodiment, the processor 103 is operable to receive the connection request from the responder device through at least one secure connection.

In one embodiment, the at least one secure connection comprises QR code scanning, Near Field Communication (NFC) tag scanning, a request raised by an application associated with the responder device, a bar code scanning, and Radio Frequency Identification (RFID) tag scanning.

In one embodiment, the authorization level comprises high-level access, mid-level access and basic level access.

In one embodiment, the role and the authorization level of the responder are determined based on a responder profile retrieved from the database.

In one embodiment, the responder profile comprises personal identification information, authentication information, role information, and authorization information.

In one embodiment, the personal identification information comprises an employee ID, name, and contact information of the responder.

In one embodiment, the authentication information comprises biometric data, an authentication token, and user credentials of the responder.

In one embodiment, the role information comprises job title, department, and hierarchical level of the responder.

In one embodiment, the authorization information comprises access level, assigned duties, and specific permissions of the responder.

In one embodiment, the authentication code comprises a time-based one-time password (TOTP) generated using a secret key and synchronized clocks between the responder device and the vehicle.

In one embodiment, the authentication code comprises a unique identifier generated based on the biometric data of the responder.

In one embodiment, the biometric data comprises fingerprint and iris scan of the responder.

In one embodiment, the authentication code comprises a cryptographic hash generated from a combination of identity information of the responder and a secret key shared between the vehicle and the responder device.

In one embodiment, the processor 103 is operable to dynamically update the authentication code at regular intervals.

In one embodiment, the processor 103 is operable to invalidate the authentication code upon transmitting the segment of status information to the responder device.

In one embodiment, the processor 103 is operable to generate a dataset based on status information.

In one embodiment, the dataset is stored in the database.

In one embodiment, the status information comprises at least one of vehicle identification number (VIN), make and model, year of manufacture, license plate number, registration status of the vehicle, owner's name, owner's address, owner's contact details, insurance details, current location, speed, fuel level, mileage, maintenance history of the vehicle, accident history, service history, damage reports, traffic penalty information, recent incident information, occupant information, historical incident information, insurance claims, recall information, legal and compliance records, and customization history.

In one embodiment, the machine learning model is trained using the dataset.

In one embodiment, the processor 103 is operable to categorize, using the machine learning model, the status information into one or more segments.

In one embodiment, the processor 103 is operable to select the segment of status information from the one or more segments based on the role and the authorization level of the responder.

In one embodiment, the one or more segments comprise at least one of a general information segment, an owner information segment, an operational data segment, a case history data segment, and an incident-specific data segment. In one embodiment, the general information segment comprises at least one of vehicle identification number (VIN), make and model, year of manufacture, license plate number, and registration status of the vehicle. In one embodiment, the owner information segment comprises owner's name, owner's address, owner's contact details and insurance details. In one embodiment, the operational data segment comprises at least one of current location, speed, fuel level, mileage, and maintenance history of the vehicle. In one embodiment, the incident-specific data segment comprises at least one of accident history, service history, damage reports, traffic penalty information, recent incident information and occupant information. In one embodiment, the case history data segment comprises historical incident information, insurance claims, recall information, legal and compliance records, and customization history.

In one embodiment, the processor 103 is operable to determine a status information accessible level in each segment based on the authorization level of the responder.

In one embodiment, the processor 103 is operable to adjust the status information based on real-time updates on the authorization level of the responder.

In one embodiment, the processor 103 is operable to adjust the status information accessible level in each segment based on proximity of the responder device to the vehicle. In one embodiment, the processor 103 is operable to adjust the status information accessible level in each segment based on an urgency of a situation. In one embodiment, the processor 103 is operable to determine the urgency of the situation within the vehicle based on an input received from a sensor module associated with the vehicle.

In one embodiment, the processor 103 is operable to adjust the status information accessible level in each segment based on historical access patterns and sensitivity score of the responder. In one embodiment, the processor 103 is operable to assign the sensitivity score to the responder based on a frequency and duration of historical access sessions to the status information and behavioral analysis of responder's interactions with the system 101. In one embodiment, the processor 103 is operable to adjust the status information accessible level in each segment based on recent vehicle activity.

In one embodiment, the status information accessible level in each segment is adjusted automatically.

In one embodiment, the status information accessible level in each segment is adjusted based on an owner preference. In one embodiment, the processor 103 is operable to display an interactive menu onto a display of the vehicle depicting the status information. In one embodiment, the processor 103 is operable to receive the owner preference comprising a list of status information to be transmitted to the responder.

In one embodiment, the processor 103 is operable to transmit an alert to vehicle owner or administrator when the responder accesses the segment of status information.

In one embodiment, the processor 103 is operable to receive an additional status information request from the responder. In one embodiment, the processor 103 is operable to retrieve additional status information based on the authorization level and the role of the responder upon receiving the additional status information request from the responder.

In one embodiment, the processor 103 is operable to encrypt the segment of status information before transmitting the segment status information to the responder device. In one embodiment, the processor 103 is operable to decrypt the segment of status information upon receiving a valid authentication token from the responder device.

In one embodiment, the processor 103 is operable to establish the connection with the responder device through a network. In one embodiment, the network comprises a communication network selected from a group comprising wired networks, wireless networks, and a combination thereof.

In one embodiment, the system 101 is integrated into the vehicle.

How Technical Solution is a Technological Advancement: The technical solution improves vehicle information management by automating and securing the process for responders. The technical solution enables real-time data retrieval and categorization according to authorization levels, which enhances the efficiency and accuracy of accessing critical vehicle information. By integrating machine learning, the technical solution optimizes the retrieval of relevant data, improving response times and decision-making. The automation reduces the need for manual data collection and minimizes errors, leading to more reliable and timely information. This enhancement not only improves operational efficiency but also improves public safety and reduces operational costs.

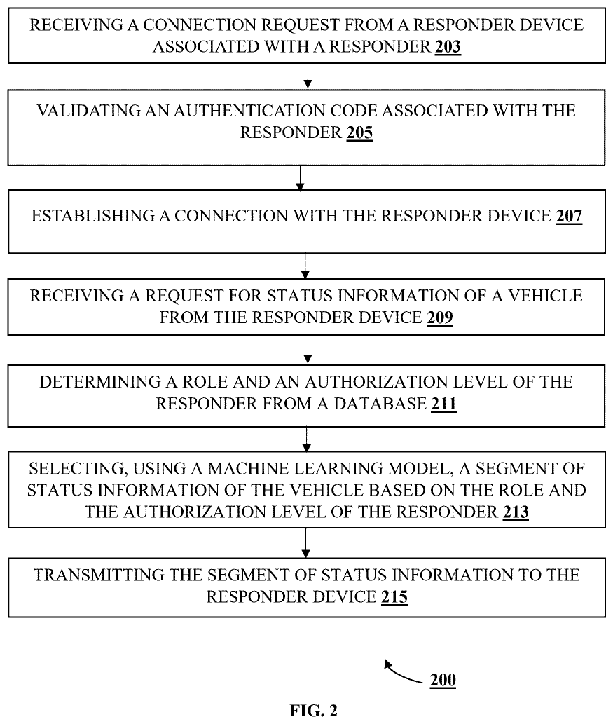

In one aspect, a method is described. As an example, FIG. 2 illustrates a method 200 according to one or more embodiments. The method 200 comprises the following technical steps: receiving a connection request from a responder device associated with a responder (at step 203); validating an authentication code associated with the responder (at step 205); establishing a connection with the responder device (at step 207); receiving a request for status information of a vehicle from the responder device (at step 209); determining a role and an authorization level of the responder from a database (at step 211); selecting, using a machine learning model, a segment of status information of the vehicle based on the role and the authorization level of the responder (at step 213); and transmitting the segment of status information to the responder device (at step 215).

In one embodiment, the method further comprises: receiving the connection request from the responder device through at least one secure connection. In one embodiment, the at least one secure connection comprises QR code scanning, Near Field Communication (NFC) tag scanning, a request raised by an application associated with the responder device, a bar code scanning, and Radio Frequency Identification (RFID) tag scanning.

In one embodiment, the authorization level comprises high-level access, mid-level access and basic level access.

In one embodiment, the role and the authorization level of the responder are determined based on a responder profile retrieved from the database. In one embodiment, the responder profile comprises personal identification information, authentication information, role information, and authorization information. In one embodiment, the personal identification information comprises an employee ID, name, and contact information of the responder. In one embodiment, the authentication information comprises biometric data, an authentication token, and user credentials of the responder. In one embodiment, the role information comprises job title, department, and hierarchical level of the responder.

In one embodiment, the authorization information comprises access level, assigned duties, and specific permissions of the responder. In one embodiment, the authentication code comprises a time-based one-time password (TOTP) generated using a secret key and synchronized clocks between the responder device and the vehicle. In one embodiment, the authentication code comprises a unique identifier generated based on the biometric data of the responder. In one embodiment, the biometric data comprises fingerprint and iris scan of the responder.

In one embodiment, the authentication code comprises a cryptographic hash generated from a combination of identity information of the responder and a secret key shared between the vehicle and the responder device.

In one embodiment, the method further comprises: dynamically updating the authentication code at regular intervals.

In one embodiment, the method further comprises: invalidating the authentication code upon transmitting the segment of status information to the responder device. In one embodiment, the method further comprises: generating a dataset based on status information. In one embodiment, the dataset is stored in the database.

In one embodiment, the status information comprises at least one of vehicle identification number (VIN), make and model, year of manufacture, license plate number, registration status of the vehicle, owner's name, owner's address, owner's contact details, insurance details, current location, speed, fuel level, mileage, maintenance history of the vehicle, accident history, service history, damage reports, traffic penalty information, recent incident information, occupant information, historical incident information, insurance claims, recall information, legal and compliance records, and customization history. In one embodiment, the machine learning model is trained using the dataset.

In one embodiment, the method further comprises: categorizing, using the machine learning model, the status information into one or more segments. In one embodiment, the method further comprises: selecting the segment of status information from the one or more segments based on the role and the authorization level of the responder. In one embodiment, the one or more segments comprise at least one of a general information segment, an owner information segment, an operational data segment, a case history data segment, and an incident-specific data segment. In one embodiment, the general information segment comprises at least one of vehicle identification number (VIN), make and model, year of manufacture, license plate number, and registration status of the vehicle. In one embodiment, the owner information segment comprises owner's name, owner's address, owner's contact details and insurance details. In one embodiment, the operational data segment comprises at least one of current location, speed, fuel level, mileage, and maintenance history of the vehicle. In one embodiment, the incident-specific data segment comprises at least one of accident history, service history, damage reports, traffic penalty information, recent incident information and occupant information. In one embodiment, the case history data segment comprises historical incident information, insurance claims, recall information, legal and compliance records, and customization history.

In one embodiment, the method further comprises: determining a status information accessible level in each segment based on the authorization level of the responder. In one embodiment, the method further comprises: adjusting the status information accessible level in each segment based on real-time updates on the authorization level of the responder.

In one embodiment, the method further comprises: adjusting the status information accessible level in each segment based on proximity of the responder device to the vehicle.

In one embodiment, the method further comprises: adjusting the status information accessible level in each segment based on an urgency of a situation. In one embodiment, the method further comprises: determining the urgency of the situation within the vehicle based on an input received from a sensor module associated with the vehicle.

In one embodiment, the method further comprises: adjusting the status information accessible level in each segment based on historical access patterns and sensitivity score of the responder. In one embodiment, the method further comprises: assigning the sensitivity score to the responder based on a frequency and duration of historical access sessions to the status information and behavioral analysis of responder's interactions with a system.

In one embodiment, the method further comprises: adjusting the status information accessible level in each segment based on recent vehicle activity. In one embodiment, the status information accessible level in each segment is adjusted automatically. In one embodiment, the status information accessible level in each segment is adjusted based on an owner preference.

In one embodiment, the method further comprises: displaying an interactive menu onto a display of the vehicle depicting the status information. In one embodiment, the method further comprises: receiving the owner preference comprising a list of status information to be transmitted to the responder.

In one embodiment, the method further comprises: transmitting an alert to vehicle owner or administrator when the responder accesses the segment of status information.

In one embodiment, the method further comprises: receiving an additional status information request from the responder. In one embodiment, the method further comprises: retrieving additional status information based on the authorization level and the role of the responder upon receiving the additional status information request from the responder.

In one embodiment, the method further comprises: encrypting the segment of status information before transmitting the segment status information to the responder device. In one embodiment, the method further comprises: decrypting the segment of status information upon receiving a valid authentication token from the responder device.

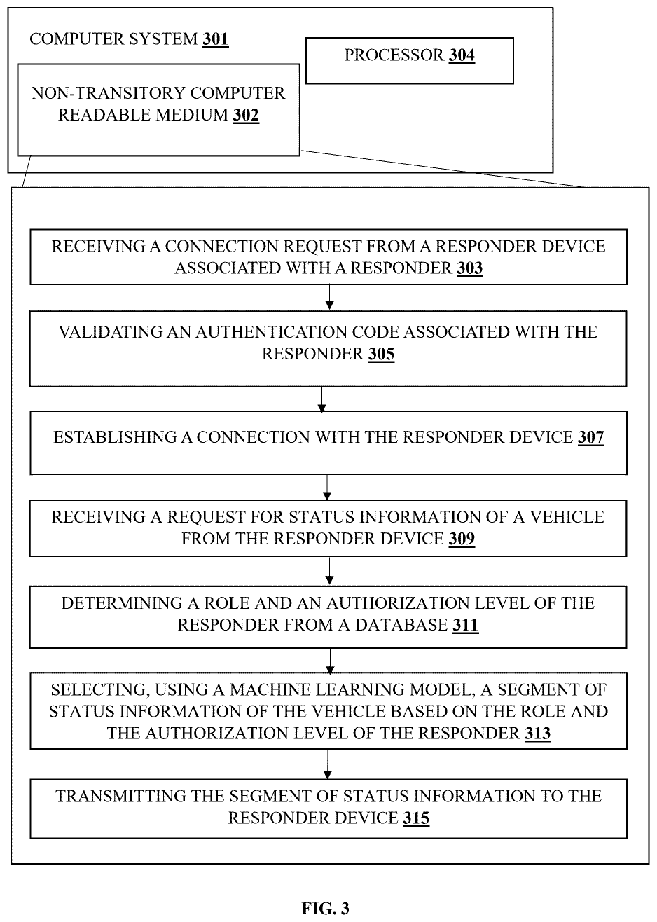

As an example, FIG. 3 illustrates a non-transitory computer readable storage medium 302, according to one or more embodiments. According to an embodiment, disclosed is a computer system 301 comprising the non-transitory computer-readable medium 302 having stored thereon instructions executable by a processor 304 to perform operations comprising: receiving a connection request from a responder device associated with a responder (at step 303); validating an authentication code associated with the responder (at step 305); establishing a connection with the responder device (at step 307); receiving a request for status information of a vehicle from the responder device (at step 309); determining a role and an authorization level of the responder from a database (at step 311); selecting, using a machine learning model, a segment of status information of the vehicle based on the role and the authorization level of the responder (at step 313); and transmitting the segment of status information to the responder device (at step 315).

In one embodiment, the non-transitory computer readable storage medium further causes: receiving the connection request from the responder device through at least one secure connection. In one embodiment, the at least one secure connection comprises QR code scanning, Near Field Communication (NFC) tag scanning, a request raised by an application associated with the responder device, a bar code scanning, and Radio Frequency Identification (RFID) tag scanning.

In one embodiment, the authorization level comprises high-level access, mid-level access and basic level access.

In one embodiment, the role and the authorization level of the responder are determined based on a responder profile retrieved from the database. In one embodiment, the responder profile comprises personal identification information, authentication information, role information, and authorization information. In one embodiment, the personal identification information comprises an employee ID, name, and contact information of the responder. In one embodiment, the authentication information comprises biometric data, an authentication token, and user credentials of the responder. In one embodiment, the role information comprises job title, department, and hierarchical level of the responder.

In one embodiment, the authorization information comprises access level, assigned duties, and specific permissions of the responder. In one embodiment, the authentication code comprises a time-based one-time password (TOTP) generated using a secret key and synchronized clocks between the responder device and the vehicle. In one embodiment, the authentication code comprises a unique identifier generated based on the biometric data of the responder. In one embodiment, the biometric data comprises fingerprint and iris scan of the responder.

In one embodiment, the authentication code comprises a cryptographic hash generated from a combination of identity information of the responder and a secret key shared between the vehicle and the responder device.

In one embodiment, the non-transitory computer readable storage medium further causes: dynamically updating the authentication code at regular intervals.

In one embodiment, the non-transitory computer readable storage medium further causes: invalidating the authentication code upon transmitting the segment of status information to the responder device. In one embodiment, the non-transitory computer readable storage medium further causes: generating a dataset based on status information. In one embodiment, the dataset is stored in the database.

In one embodiment, the status information comprises at least one of vehicle identification number (VIN), make and model, year of manufacture, license plate number, registration status of the vehicle, owner's name, owner's address, owner's contact details, insurance details, current location, speed, fuel level, mileage, maintenance history of the vehicle, accident history, service history, damage reports, traffic penalty information, recent incident information, occupant information, historical incident information, insurance claims, recall information, legal and compliance records, and customization history. In one embodiment, the machine learning model is trained using the dataset.

In one embodiment, the non-transitory computer readable storage medium further causes: categorizing, using the machine learning model, the status information into one or more segments. In one embodiment, the non-transitory computer readable storage medium further causes: selecting the segment of status information from the one or more segments based on the role and the authorization level of the responder. In one embodiment, the one or more segments comprise at least one of a general information segment, an owner information segment, an operational data segment, a case history data segment, and an incident-specific data segment. In one embodiment, the general information segment comprises at least one of vehicle identification number (VIN), make and model, year of manufacture, license plate number, and registration status of the vehicle. In one embodiment, the owner information segment comprises owner's name, owner's address, owner's contact details and insurance details. In one embodiment, the operational data segment comprises at least one of current location, speed, fuel level, mileage, and maintenance history of the vehicle. In one embodiment, the incident-specific data segment comprises at least one of accident history, service history, damage reports, traffic penalty information, recent incident information and occupant information. In one embodiment, the case history data segment comprises historical incident information, insurance claims, recall information, legal and compliance records, and customization history.

In one embodiment, the non-transitory computer readable storage medium further causes: determining a status information accessible level in each segment based on the authorization level of the responder. In one embodiment, the non-transitory computer readable storage medium further causes: adjusting the status information accessible level in each segment based on real-time updates on the authorization level of the responder.

In one embodiment, the non-transitory computer readable storage medium further causes: adjusting the status information accessible level in each segment based on proximity of the responder device to the vehicle. In one embodiment, the non-transitory computer readable storage medium further causes: adjusting the status information accessible level in each segment based on an urgency of a situation. In one embodiment, the non-transitory computer readable storage medium further causes: determining the urgency of the situation within the vehicle based on an input received from a sensor module associated with the vehicle.

In one embodiment, the non-transitory computer readable storage medium further causes: adjusting the status information accessible level in each segment based on historical access patterns and sensitivity score of the responder. In one embodiment, the non-transitory computer readable storage medium further causes: assigning the sensitivity score to the responder based on a frequency and duration of historical access sessions to the status information and behavioral analysis of responder's interactions with a system.

In one embodiment, the non-transitory computer readable storage medium further causes: adjusting the status information accessible level in each segment based on recent vehicle activity. In one embodiment, the status information accessible level in each segment is adjusted automatically.

In one embodiment, the status information accessible level in each segment is adjusted based on an owner preference. In one embodiment, the non-transitory computer readable storage medium further causes: displaying an interactive menu onto a display of the vehicle depicting the status information. In one embodiment, the non-transitory computer readable storage medium further causes: receiving the owner preference comprising a list of status information to be transmitted to the responder. In one embodiment, the non-transitory computer readable storage medium further causes: transmitting an alert to vehicle owner or administrator when the responder accesses the segment of status information.

In one embodiment, the non-transitory computer readable storage medium further causes: receiving an additional status information request from the responder. In one embodiment, the non-transitory computer readable storage medium further causes: retrieving additional status information based on the authorization level and the role of the responder upon receiving the additional status information request from the responder.

In one embodiment, the non-transitory computer readable storage medium further causes: encrypting the segment of status information before transmitting the segment status information to the responder device.

In one embodiment, the non-transitory computer readable storage medium further causes: decrypting the segment of status information upon receiving a valid authentication token from the responder device.

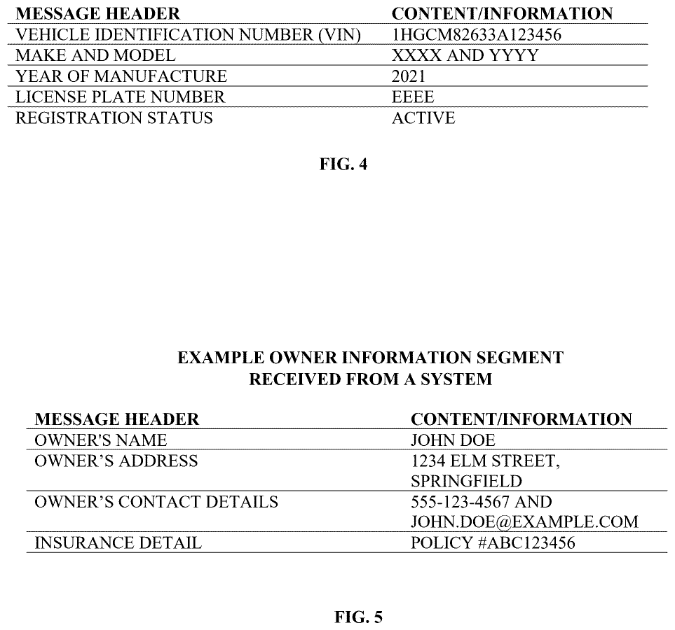

As an example, FIG. 4 illustrates a general information segment received from a system, according to one or more embodiments. The general information segment comprises fields such as vehicle identification number (VIN), make and model, year of manufacture, license plate number, and registration status of the vehicle. The vehicle identification number (VIN) refers to a unique alphanumeric code assigned to each vehicle, such as “1HGBH41JXMN109186,” which is used for identification and tracking. The make and model refer to the manufacturer and specific type of the vehicle, such as “XXXX XXXX,” providing details about the brand and design of the vehicle. The year of manufacture indicates the production year of the vehicle, such as “20XX,” which helps determine its age and compliance with various standards. The license plate number is a unique registration number displayed on the vehicle's license plate, such as “XYZ-5678,” used for identification on the road. The registration status reflects the current validity of the vehicle's registration, such as “Active,” indicating whether the registration is current and up to date.

As an example, FIG. 5 illustrates owner information segment received from a system according to one or more embodiments. The owner information segment comprises fields such as owner's name, owner's address, owner's contact details and insurance details. The owner's name represents the full name of the vehicle owner, such as “John Doe” for identification purposes. The owner's address provides the residential or business location of the owner, such as “1234 Elm Street, Springfield,” which is useful for correspondence and verification. The owner's contact details comprise phone numbers or email addresses, such as “555-123-4567” or “john.doe@example.com” enabling direct communication. The insurance details comprise information about the vehicle's insurance coverage, including the provider and policy number, such as “Policy #ABC123456,” confirming that the vehicle is insured and detailing the coverage.

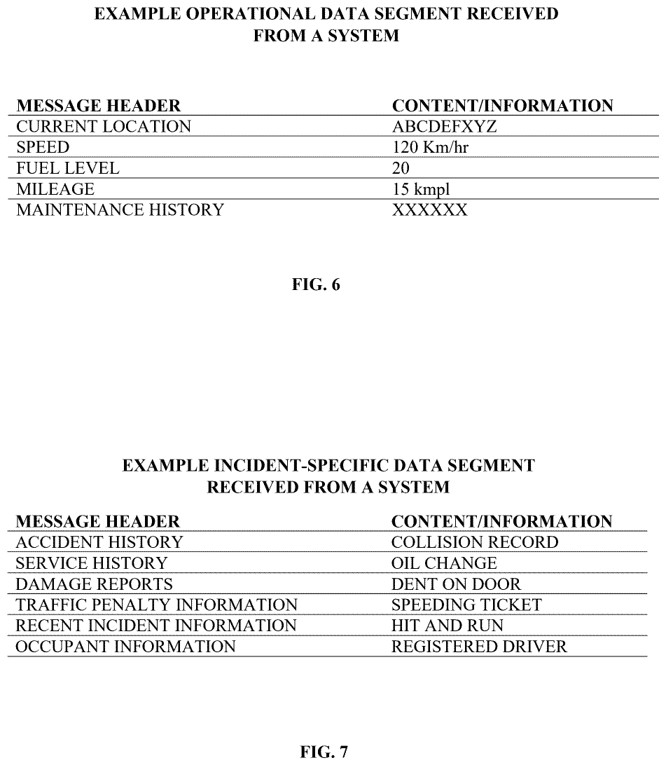

As an example, FIG. 6 illustrates an operational data segment received from a system according to one or more embodiments. The operational data segment comprises fields such as current location, speed, fuel level, mileage, and maintenance history of the vehicle. The current location indicates the vehicle's real-time geographic position, which can be represented by coordinates or an address. The speed reflects the vehicle's current traveling speed, typically measured in miles per hour (mph) or kilometers per hour (km/h). The fuel level shows the amount of fuel remaining in the tank, often expressed as a percentage or in gallons/liters. The mileage represents the total distance the vehicle has travelled, recorded in miles or kilometers. Further, the maintenance history provides a record of past maintenance and repairs performed on the vehicle, detailing dates, types of services, and parts replaced.

As an example, FIG. 7 illustrates an incident-specific data segment received from a system according to one or more embodiments. The incident-specific data segment comprises fields such as accident history, service history, damage reports, traffic penalty information, recent incident information and occupant information. The accident history provides a record of past accidents involving the vehicle, detailing incidents such as collisions or other impacts. The service history comprises information on routine maintenance and repairs performed on the vehicle, such as oil changes or brake replacements. The damage reports document any physical damage sustained by the vehicle, including details about the location and extent of the damage. The traffic penalty information lists any fines or violations associated with the vehicle, such as speeding tickets or parking citations. The recent incident information covers recent events involving the vehicle, such as recent accidents or near-misses. Further, the occupant information provides details about the individuals inside the vehicle during incidents, including their identities and roles.

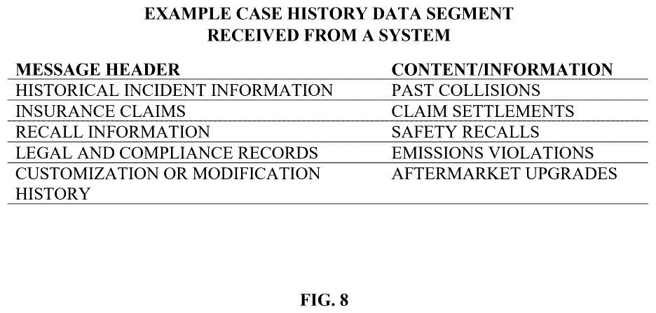

As an example, FIG. 8 illustrates case history data segment received from a system according to one or more embodiments. The case history data segment comprises fields such as historical incident information, insurance claims, recall information, legal and compliance records, and customization history. The historical incident information comprises records of past incidents involving the vehicle, such as previous accidents or major repairs. The insurance claims detail any claims made against the vehicle's insurance policy, including the nature of the claims and their resolution. The recall information comprises data on any safety recalls issued for the vehicle, detailing the reasons for the recalls and any actions taken. The legal and compliance records provide information on legal matters and regulatory compliance, such as emissions violations or other legal issues. The customization history tracks any changes made to the vehicle from its original specifications, including aftermarket upgrades or modifications.

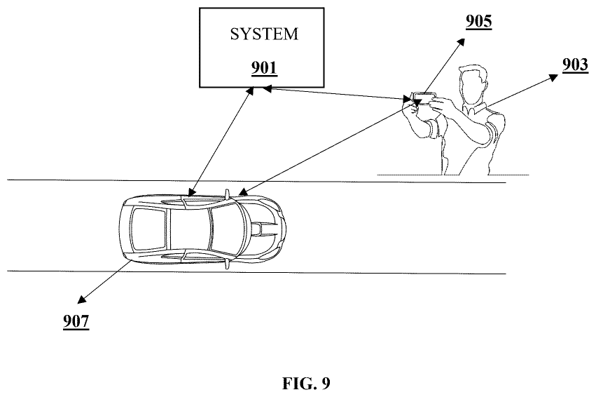

As an example, FIG. 9 illustrates a block diagram of a system 901 for accessing status information of a vehicle 907 according to one or more embodiments. The block diagram comprises the system 901, a responder device 905 associated with a responder 903 (e.g., a police officer) and the vehicle 907. The system 901 receives a connection request from the responder device 905 associated with the responder 903. In one embodiment, the responder 903 initiates the connection request through at least one secure connection. In one embodiment, the at least one secure connection comprises QR code scanning, Near Field Communication (NFC) tag scanning, a request raised by an application associated with the responder device 905, a bar code scanning, and Radio Frequency Identification (RFID) tag scanning. The responder 903 may be a police officer, mechanic, or another authorized individual. The system 901 validates an authentication code associated with the responder 903. In one embodiment, the authentication code comprises a time-based one-time password (TOTP) generated using a secret key and synchronized clocks between the responder device 905 and the vehicle 907.

In one embodiment, the authentication code comprises a unique identifier generated based on the biometric data of the responder 903. In one embodiment, the biometric data comprises fingerprint and iris scan of the responder 903. In one embodiment, the authentication code comprises a cryptographic hash generated from a combination of the identity information of the responder 903 and a secret key shared between the vehicle 907 and the responder device 905. In one embodiment, the system 901 dynamically updates the authentication code at regular intervals. In one embodiment, the system 901 invalidates the authentication code upon transmitting the segment of status information to the responder device 905. The system 901 establishes a connection with the responder device 905. The connection may be established with the responder device 905 through a network. In one embodiment, the network comprises a communication network selected from a group comprising wired networks, wireless networks, and a combination thereof.

The system 901 receives a request for status information of the vehicle 907 from the responder device 905. The system 901 determines a role and an authorization level of the responder 903 (e.g., police officer) from a database. In one embodiment, the authorization level comprises high-level access, mid-level access and basic level access. The authorization level of the police officer accessing the system 901 would typically be classified as high, due to the nature of their duties and the necessity for them to access detailed and sensitive information for law enforcement purposes. The system 901 may select the incident-specific data segment to be transmitted to the responder 903 (e.g., police officer). This segment comprises information such as accident history, recent incidents, damage reports, traffic penalty information, and occupant information, all of which are essential for law enforcement purposes. The system 901 transmits the segment of status information to the responder device 905.

In an embodiment, the system 901 determines a status information accessible level in each segment based on the authorization level of the responder 903. In one embodiment, the system 901 adjusts the status information accessible level in each segment based on real-time updates on the authorization level of the responder 903. In one embodiment, the system 901 adjusts the status information accessible level in each segment based on proximity of the responder device 905 to the vehicle 907. In one embodiment, the system 901 adjusts the status information accessible level in each segment based on an urgency of a situation. In one embodiment, the system 901 determines the urgency of the situation within the vehicle 907 based on an input received from a sensor module associated with the vehicle 907.

For example, in an emergency situation involving a police officer, the system 901 detects the emergency through input from the sensor module associated with the vehicle 907, such as the detection of airbag deployment. Upon recognizing the collision, the system 901 initiates a protocol to adjust data accessibility levels according to predefined emergency response rules. The system 901 first detects the accident through sensors, such as an airbag deployment sensor, and determines the urgency of the situation based on the sensor input. In such emergencies, the system 901 overrides normal user permissions based on pre-configured settings for emergency situations. Recognizing that the responder 903 (e.g., police officer) has the authority equivalent to emergency crews during an accident, the system 901 automatically provides data to emergency responders. This is especially helpful and efficient in situations when the driver is unable to grant permissions (e.g., if the driver is unconscious).

The system 901 adjusts the accessible levels of one or more segments to provide critical information. For the incident-specific data segment, the system 901 provides detailed information about the accident history, recent incidents, damage reports, traffic penalty information, and occupant information, which are important for emergency responders to assess the situation and provide assistance. The operational data segment provides real-time data such as current location, speed at the time of the crash, fuel level, and maintenance history to enable the responder 903 to understand the vehicle's condition and the dynamics of the accident. Additionally, the case history data segment grants access to historical incident information, insurance claims, and legal records, offering responder 903 a comprehensive understanding of the vehicle's background and any relevant legal considerations. In an embodiment, the system 901 adjusts data accessibility based on the proximity of the responder device 905 to the vehicle 907. As the police officer or emergency crew approaches the vehicle 907, higher levels of detailed data become available to aid in the emergency response. In an embodiment, users or occupants may have pre-specified information that needs to be automatically provided after a crash. Upon detecting the collision, the system 901 switches to these pre-specified permissions, ensuring that the right information is shared without the need for manual intervention. For example, a user might have set permissions to automatically share medical information or emergency contact details in the event of a serious accident. The system 901 enables granular permissions, allowing for various levels of data access to be specified for various emergency situations. For example, police officers may be granted access to detailed crash reports and occupant information, while medical personnel may be given access to occupant medical history and emergency contacts. By dynamically adjusting the status information accessible level in each segment based on real-time factors and pre-configured emergency rules, the system 901 ensures that critical information is efficiently provided to authorized responders during an emergency, enhancing the effectiveness of the response and improving the safety and security of the vehicle occupants.

The system 901 may receive an additional status information request from the responder 903 (e.g., the police officer). For example, the responder 903 requests the additional status information such as information about actions or movements of the vehicle 907 over the last 5 miles and information subject to legal checks before disclosure of private data. Upon verifying the police officer's high authorization level, the system 901 processes a request for the additional status information. This request comprises access to the operational data segment, providing real-time data such as the vehicle's current location, speed, fuel level, and mileage. Further, the system 901 grants access to the case history data segment, which comprises information on historical incident information, insurance claims, recall information, legal and compliance records, and customization history.

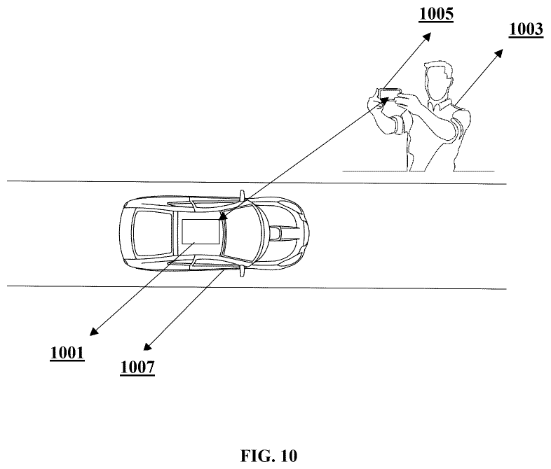

As an example, FIG. 10 illustrates a block diagram of a system 1001 integrated into a vehicle 1007 according to one or more embodiments. The block diagram comprises the system 1001, a responder device 1005 associated with the responder 1003 and the vehicle 1007. Despite this integration, the functionality of the system 1001 remains the same as when the system 1001 is external to the vehicle 1007 (as depicted in FIG. 9).

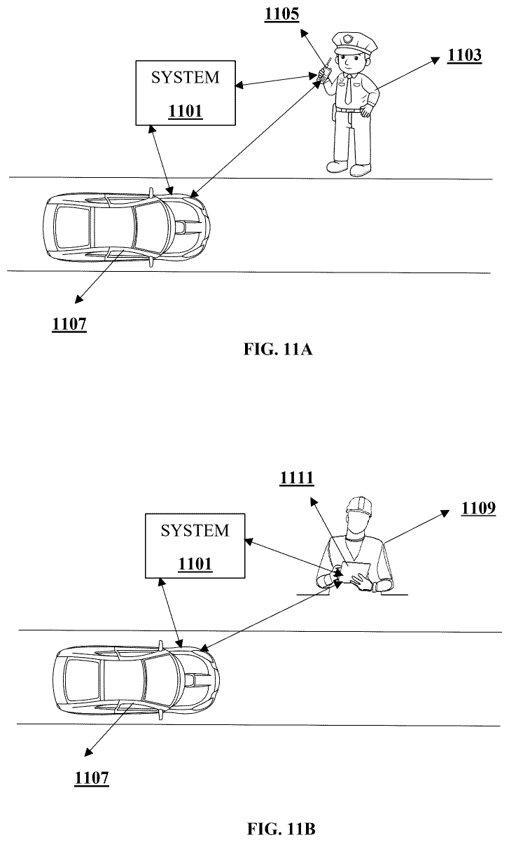

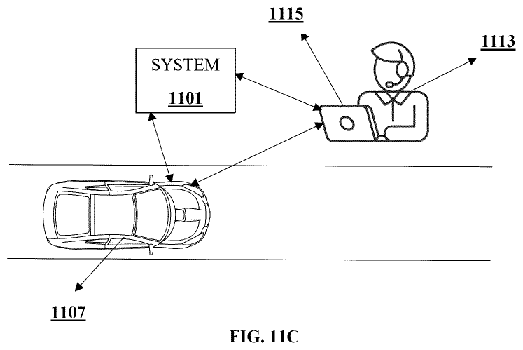

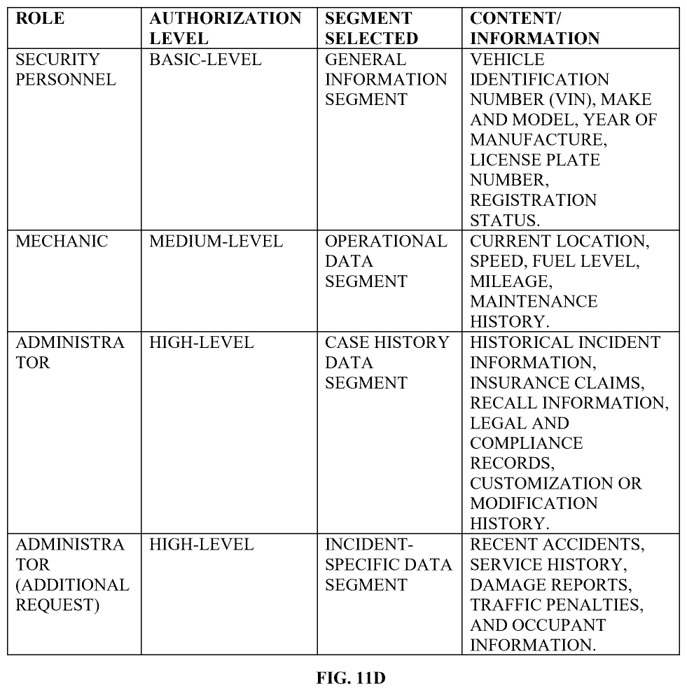

As an example, FIG. 11A illustrates the process of accessing the status information of a vehicle 1107 by a first responder 1103 (e.g., security personnel) as the vehicle 1107 enters a service center according to one or more embodiments. The system 1101 starts by receiving a connection request from a first responder device 1105 associated with the first responder 1103 (e.g., security personnel). The system 1101 then validates the authentication code provided by the security personnel. Upon successful validation, the system 1101 establishes a connection with the first responder device 1105 (e.g., security personnel's device). When the security personnel's device requests status information, the system 1101 checks the database to determine the role and the authorization level of the security personnel. Using a machine learning model, the system 1101 selects the segment of status information relevant to their role and the authorization level. For security personnel access, the segment of status information that can be accessed is the general information segment. The general information segment comprises the Vehicle Identification Number (VIN), make and model, year of manufacture, license plate number, and registration status. The security personnel, having basic-level access, can only retrieve this general information to confirm that the vehicle 1107 meets entry requirements without accessing more detailed or sensitive data. The system 1101 transmits this general information segment to the security personnel's device.

As an example, FIG. 11B illustrates the process of accessing the status information of a vehicle 1107 by a second responder 1109 (e.g., a mechanic) when the vehicle 1107 is undergoing maintenance at the service center according to one or more embodiments. The system 1101 starts by receiving a connection request from a second responder device 1111 associated with the second responder 1109 (e.g., mechanic). The system 1101 then validates the authentication code provided by the mechanic. Upon successful validation, the system 1101 establishes a connection with the second responder device 1111 (e.g., the mechanic's device). When the mechanic's device requests status information of the vehicle 1107, the system 1101 checks the database to determine the role and authorization level of the mechanic. Using a machine learning model, the system 1101 selects the segment of status information appropriate for their role and authorization level. For mechanical access, the segment of status information that can be accessed is the operational data segment. This segment comprises the current location, speed, fuel level, mileage, and maintenance history of the vehicle 1107. The mechanic, having mid-level access, can retrieve this operational data to assist with diagnostics and repairs without accessing more sensitive information. The system 1101 transmits this operational data segment to the mechanic's device.

As an example, FIG. 11C illustrates the process of accessing the status information of the vehicle 1107 by a third responder 1113 (e.g., an administrator) when managing comprehensive vehicle records at the service center according to one or more embodiments. The system 1101 starts by receiving a connection request from a third responder device 1115 associated with the third responder 1113 (e.g., administrator). The system 1101 then validates the authentication code provided by the administrator. Upon successful validation, the system 1101 establishes a connection with the third responder device 1115 (e.g., the administrator's device). When the administrator's device requests status information of the vehicle 1107, the system 1101 checks the database to determine the role and authorization level of the administrator. Using a machine learning model, the system 1101 selects the segment of status information relevant to their high-level access. For administrator access, the segment of status information that can be accessed is the case history data segment. This segment comprises historical incident information, insurance claims, recall information, legal and compliance records, and customization history. The administrator, having high-level access, can retrieve this comprehensive data to manage and oversee all aspects of the vehicle's history effectively. The system 1101 transmits this case history data segment to the administrator's device.

In an embodiment, if the administrator requests additional status information beyond the case history data segment, the system 1101 may provide access to the incident-specific data segment. This segment comprises detailed information on recent accidents, service history, damage reports, traffic penalties, and occupant information.

As an example, FIG. 11D illustrates selection of segments based on the role and authorization level of one or more responders according to one or more embodiments herein. The table shows how different segments of status information are provided according to the responder's role and authorization level. For example, security personnel, with basic-level access, receive the general information segment, which includes essential vehicle details. Mechanics, with mid-level access, are provided with the operational data segment, containing information for diagnostics and repairs. Administrators, having high-level access, can view the case history data segment, which includes comprehensive historical records. Additionally, if an administrator requests further details, the system can provide the additional status information to the administrator.

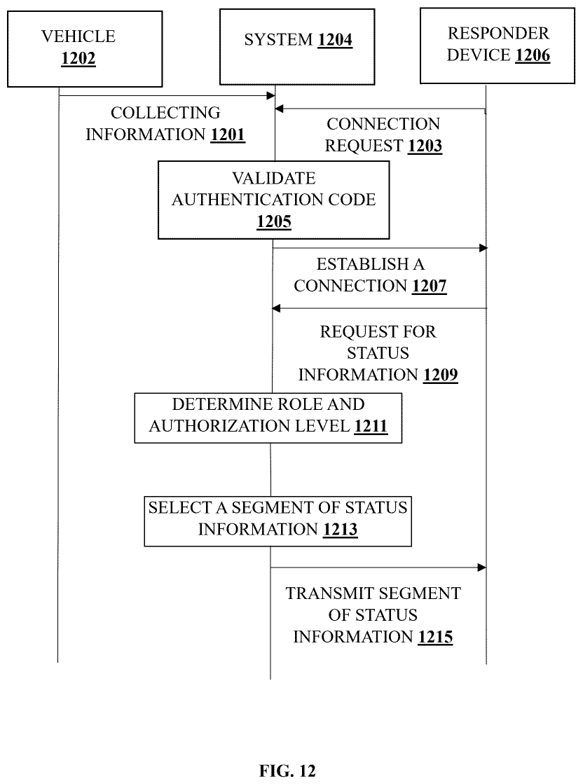

As an example, FIG. 12 illustrates a communication flow between a system 1204, a vehicle 1202, and a responder device 1206, according to one or more embodiments. At step 1201, the system 1204 collects status information from the vehicle 1202, including data such as the Vehicle Identification Number (VIN), make and model, year of manufacture, license plate number, registration status, current location, speed, fuel level, mileage, maintenance history, accident history, service history, damage reports, traffic penalties, recent incident information, and occupant details. At step 1203, the system 1204 receives a connection request from a responder device 1206 associated with a responder. At step 1205, the system 1204 validates the authentication code provided by the responder to ensure their identity and appropriate authorization level. At step 1207, the system 1204 establishes a connection with the responder device 1206 upon successful validation. When the responder's device requests status information of the vehicle 1202, at step 1209, the system 1204 checks the responder's role and authorization level from the database at step 1211. At step 1213, the system 1204 selects the appropriate segment of status information based on this role and authorization level. At step 1215, the system 1204 transmits the segment of status information to the responder device 1206.

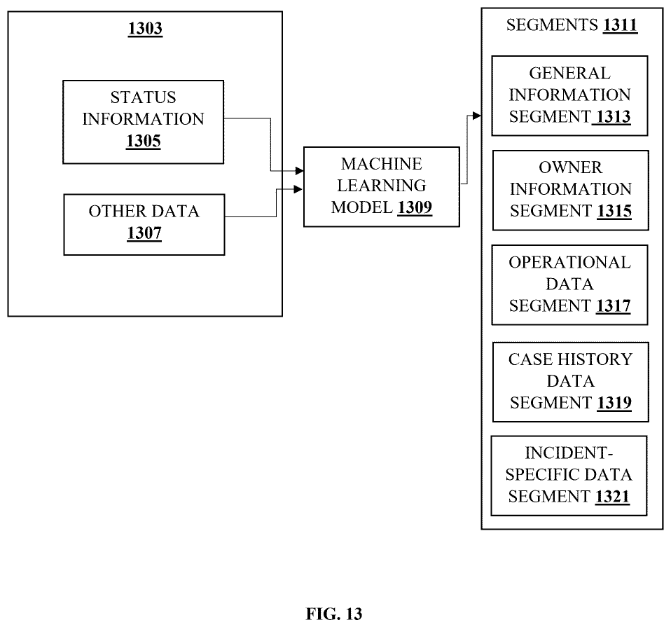

As an example, FIG. 13 shows an example block diagram for a machine learning model 1309 used in selecting a segment of status information of a vehicle according to one or more embodiments. The system generates a dataset 1303 based on status information 1305. In one embodiment, the dataset 1303 is stored in the database. In one embodiment, the status information 1305 comprises at least one of vehicle identification number (VIN), make and model, year of manufacture, license plate number, registration status of the vehicle, owner's name, owner's address, owner's contact details, insurance details, current location, speed, fuel level, mileage, maintenance history of the vehicle, accident history, service history, damage reports, traffic penalty information, recent incident information, occupant information, historical incident information, insurance claims, recall information, legal and compliance records, and customization history. In one embodiment, the machine learning model 1309 is trained using the dataset.

In addition to the status information 1305, the machine learning model 1309 is trained on a variety of other data 1307, including sensor data, user interaction data, maintenance and repair data, predictive maintenance data, anomaly detection data, fleet management data, customer feedback data, market trends, regulatory data, geospatial data, vehicle customization data, and insurance data. The sensor data provides insights from vehicle sensors and environmental conditions, while the user interaction data captures driver behavior and infotainment system usage. The maintenance and repair data, including historical repair logs and service recommendations, support predictive maintenance efforts. The predictive maintenance data and anomaly detection data enable the machine learning model 1309 to anticipate component failures and detect unusual patterns. The fleet management data may provide insights for optimizing fleet operations, and the customer feedback data informs improvements in vehicle performance and service. Further, the market trends and regulatory data provide broader context for decision-making, the geospatial data aids in route planning, the vehicle customization data caters to individual user preferences, and insurance data supports risk assessment and policy adjustments.

The machine learning model 1309 categorizes the status information into one or more segments 1311. The machine learning model 1309 selects the segment of status information from the one or more segments 1311 based on the role and the authorization level of the responder. In one embodiment, the one or more segments 1311 comprise at least one of a general information segment 1313, an owner information segment 1315, an operational data segment 1317, a case history data segment 1319, and an incident-specific data segment 1321.

In one embodiment, the general information segment 1313 comprises at least one of vehicle identification number (VIN), make and model, year of manufacture, license plate number, and registration status of the vehicle. In one embodiment, the owner information segment 1315 comprises owner's name, owner's address, owner's contact details and insurance details. In one embodiment, the operational data segment 1317 comprises at least one of current location, speed, fuel level, mileage, and maintenance history of the vehicle.

In one embodiment, the incident-specific data segment 1319 comprises at least one of accident history, service history, damage reports, traffic penalty information, recent incident information and occupant information. In one embodiment, the case history data segment 1321 comprises historical incident information, insurance claims, recall information, legal and compliance records, and customization history.

In an embodiment, the machine learning model is configured to learn using labelled data using a supervised learning method, wherein the supervised learning method comprises logic using at least one of a decision tree, a logistic regression, a support vector machine, a k-nearest neighbors, a Naïve Bayes, a random forest, a linear regression, a polynomial regression, and a support vector machine for regression.

In an embodiment of the system, the machine learning model is configured to learn from the real-time data using an unsupervised learning method, wherein the unsupervised learning method comprises logic using at least one of a k-means clustering, a hierarchical clustering, a hidden Markov model, and an apriori algorithm.

In an embodiment of the system, the machine learning model has a feedback loop, wherein the output from a previous step is fed back to the model in real-time to improve the performance and accuracy of the output of a next step.

In an embodiment of the system, the machine learning model comprises a recurrent neural network model.

In an embodiment of the system, the machine learning model has a feedback loop, wherein the learning is further reinforced with a reward for each true positive of the output of the system.

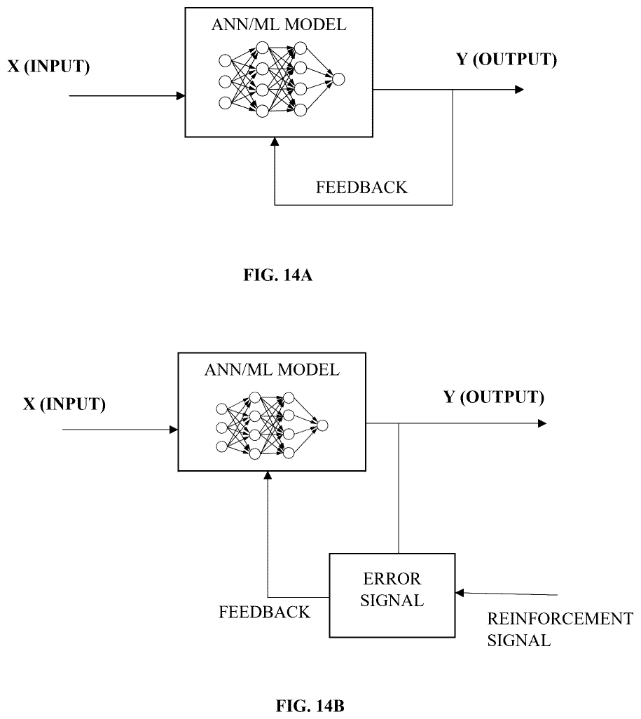

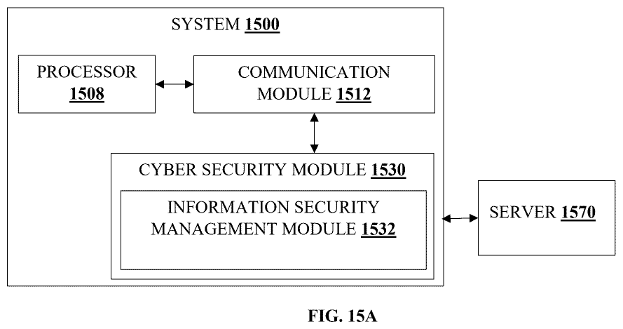

As an example, FIG. 14A shows a structure of the neural network/machine learning model with a feedback loop. Artificial neural networks (ANNs) model comprises an input layer, one or more hidden layers, and an output layer. Each node, or artificial neuron, connects to another and has an associated weight and threshold. If the output of any individual node is above the specified threshold value, that node is activated, sending data to the next layer of the network. Otherwise, no data is passed to the next layer of the network. A machine learning model or an ANN model may be trained on a set of data to take a request in the form of input data, make a prediction on that input data, and then provide a response. The model may learn from the data. Learning can be supervised learning and/or unsupervised learning and may be based on different scenarios and with different datasets. Supervised learning comprises logic using at least one of a decision tree, logistic regression, and support vector machines. Unsupervised learning comprises logic using at least one of a k-means clustering, a hierarchical clustering, a hidden Markov model, and an apriori algorithm. The output layer may select a segment of status information of the vehicle based on the role and the authorization level of the responder.

In an embodiment, ANNs may be a Deep-Neural Network (DNN), which is a multilayer tandem neural network comprising Artificial Neural Networks (ANN), Convolution Neural Networks (CNN) and Recurrent Neural Networks (RNN). Neural Networks can recognize features from inputs, do an expert review, and perform actions that require predictions, creative thinking, and analytics. In an embodiment, ANNs may be Recurrent Neural Network (RNN), which is a type of Artificial Neural Networks (ANN), which uses sequential data or time series data. Deep learning algorithms are commonly used for ordinal or temporal problems, such as language translation, Natural Language Processing (NLP), speech recognition, and image recognition, etc. Like feedforward and convolutional neural networks (CNNs), recurrent neural networks utilize training data to learn. They are distinguished by their “memory” as they take information from prior input via a feedback loop to influence the current input and output. An output from the output layer in a neural network model is fed back to the model through the feedback (error signal). The variations of weights in the hidden layer(s) will be adjusted to fit the expected outputs better while training the model. This will allow the model to provide results with far fewer mistakes.

The neural network is featured with the feedback loop to adjust the system output dynamically as it learns from the new data. In machine learning, backpropagation and feedback loops are used to train an Artificial Intelligence (AI) model and continuously improve it upon usage. As the incoming data that the model receives increases, there are more opportunities for the model to learn from the data. The feedback loops, or backpropagation algorithms, identify inconsistencies and feed the corrected information back into the model as an input.

Even though the Artificial Intelligence/Machine Learning (AI/ML) model is trained well, with large sets of labelled data and concepts, after a while, the models' performance may decline while adding new, unlabelled input due to many reasons which include, but not limited to, concept drift, recall precision degradation due to drifting away from true positives, and data drift over time. A feedback loop in the model keeps the AI results accurate and ensures that the model maintains its performance and improvement, even when new unlabelled data is assimilated. A feedback loop refers to the process by which an AI model's predicted output is reused to train new versions of the model.

Initially, when the AI/ML model is trained, a few labelled samples comprising both positive and negative examples of the concepts (for e.g., determine a role and an authorization level, select a segment of status information, etc.) are used that are meant for the model to learn. Afterward, the model is tested using unlabelled data. By using, for example, deep learning and neural networks, the model can then make predictions on whether the desired concept/s (for e.g., determine a role and an authorization level, select a segment of status information, etc.) are in unlabelled images. Each image is given a probability score where higher scores represent a higher level of confidence in the models' predictions. Where a model gives an image a high probability score, it is auto labelled with the predicted concept. However, in the cases where the model returns a low probability score, this input may be sent to a controller (may be a human moderator) which verifies and, as necessary, corrects the result. The human moderator may be used only in exception cases. The feedback loop feeds labelled data, auto-labelled or controller-verified, back to the model dynamically and is used as training data so that the system can improve its predictions in real-time and dynamically.

As an example, FIG. 14B shows a structure of the neural network/machine learning model with reinforcement learning. The network receives feedback from authorized networked environments. Though the system is similar to supervised learning, the feedback obtained in this case is evaluative not instructive, which means there is no teacher as in supervised learning. After receiving the feedback, the network performs adjustments of the weights to get better predictions in the future. Machine learning techniques, like deep learning, allow models to take labelled training data and learn to recognize those concepts in subsequent data and images. The model may be fed with new data for testing, hence by feeding the model with data it has already predicted over, the training gets reinforced. If the machine learning model has a feedback loop, the learning is further reinforced with a reward for each true positive of the output of the system. Feedback loops ensure that AI results do not stagnate. By incorporating a feedback loop, the model output keeps improving dynamically and over usage/time.

In an embodiment, icons on a graphical user interface (GUI) or display of the infotainment system of a computer system are re-arranged based on a priority score of the content of the message. The processor tracks the messages that need to be displayed at a given time and generates a priority score, wherein the priority score is determined based on the action that needs to be taken by the user, the time available before the user input is needed, content of the message to be displayed, criticality of the user's input/action that needs to be taken, the sequence of the message or messages that need to be displayed and executed, and the safety of the overall scenario. For example, in case of a health emergency, the messages in queue for displaying could be an emergency signal, type of emergency, intimation that an alert is provided to the nearby vehicles, instructing a path for the driver to pull over, calling the emergency services, etc. In all these messages that need a driver's attention, a priority score is provided based on the actions that need to be taken by the user, the time available for the user to receive the displayed message and react with an action, the content of the message, criticality of the user's input/action, sequence of the messages that need to be executed, and safety of the overall scenario. Considering the above example, the message that intimates the user/driver that an alert has been provided to nearby vehicles may be of lower priority as compared to instructing the path for the driver to pull over. Therefore, the pull over directions for the path message takes priority and takes such a place on the display (example, center of the display) which can grab the users' attention immediately. The priority of the messages are evaluated dynamically as the situation is evolving and thus the display icons, positions, and sizes of the text or icon on the display are changed in real-time and dynamically. In an embodiment, more than one message is displayed and highlighted as per the situation and the user's actions. Further, while pulling over, if an unsafe scenario is found, for example, a car is changing lanes which may obstruct the user's vehicle, the message dynamically changes and warns the driver about the developing scenario. In another scenario of a vehicle with charge less than threshold charge level, the processor dynamically reassigns the priority score and depicts nearby charging stations and navigates the route to the charging station onto a display in the dashboard.

In an embodiment, the system further comprises a cyber security module wherein the cyber security module comprises an information security management module providing isolation between the communication module and servers.

In an embodiment, the information security management module is operable to, receive data from the communication module, exchange a security key at a start of the communication between the communication module and the server, receive the security key from the server, authenticate an identity of the server by verifying the security key, analyze the security key for a potential cyber security threat, negotiate an encryption key between the communication module and the server, encrypt the data; and transmit the encrypted data to the server when no cyber security threat is detected.

In an embodiment, the information security management module is operable to exchange a security key at a start of the communication between the communication module and the server, receive the security key from the server, authenticate an identity of the server by verifying the security key, analyze the security key for a potential cyber security threat, negotiate an encryption key between the system and the server, receive encrypted data from the server, decrypt the encrypted data, perform an integrity check of the decrypted data and transmit the decrypted data to the communication module when no cyber security threat is detected.

In an embodiment, the system may comprise a cyber security module.

In one aspect, a secure communication management (SCM) computer device for providing secure data connections is provided. The SCM computer device includes a processor in communication with memory. The processor is programmed to receive, from a first device, a first data message. The first data message is in a standardized data format. The processor is also programmed to analyze the first data message for potential cyber security threats. If the determination is that the first data message does not contain a cyber security threat, the processor is further programmed to convert the first data message into a first data format associated with the vehicle environment and transmit the converted first data message to the vehicle system using a first communication protocol associated with the vehicle system.

According to an embodiment, secure authentication for data transmissions comprises, provisioning a hardware-based security engine (HSE) located in the information security management module, said HSE having been manufactured in a secure environment and certified in said secure environment as part of an approved network; performing asynchronous authentication, validation and encryption of data using said HSE, storing user permissions data and connection status data in an access control list used to define allowable data communications paths of said approved network, enabling communications of the communications system with other computing system subjects to said access control list, performing asynchronous validation and encryption of data using security engine including identifying a user device (UD) that incorporates credentials embodied in hardware using a hardware-based module provisioned with one or more security aspects for securing the system, wherein security aspects comprising said hardware-based module communicating with a user of said user device and said HSE.

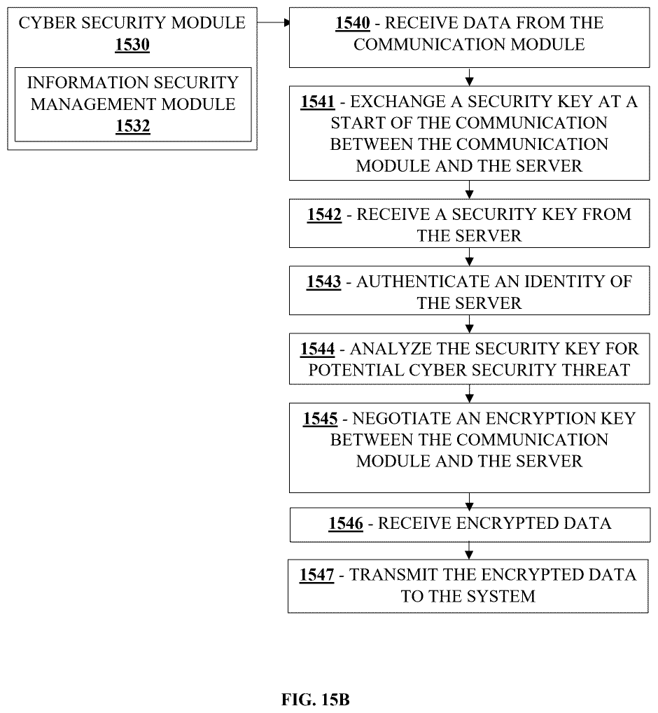

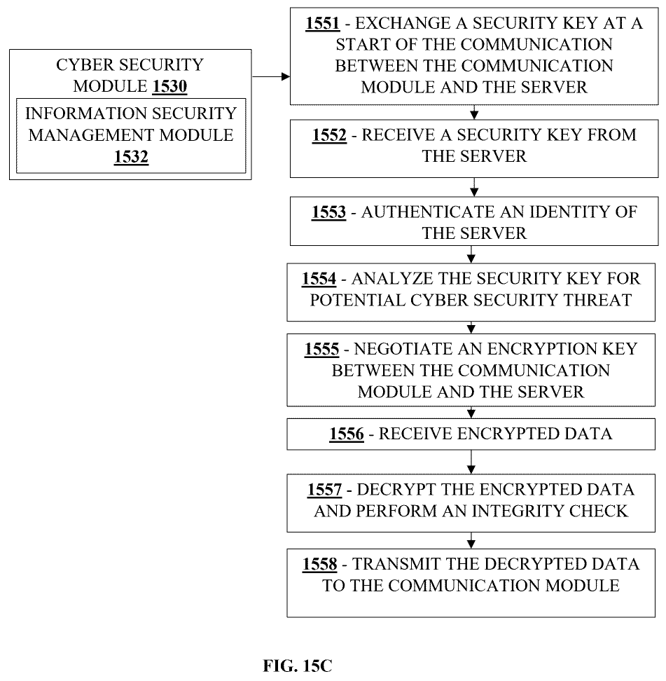

In an embodiment, FIG. 15A shows the block diagram of the cyber security module. The communication of data between the system 1500 and the server 1570, through the processor 1508, through the communication module 1512, is first verified by the information security management module 1532 before being transmitted from the system to the server or from the server to the system. The information security management module is operable to analyze the data for potential cyber security threats, to encrypt the data when no cyber security threat is detected, and to transmit the data encrypted to the system or the server.

In an embodiment, the cyber security module further comprises an information security management module providing isolation between the system and the server. FIG. 15B shows the flowchart of securing the data through the cyber security module 1530. At step 1540, the information security management module 1532 is operable to receive data from the communication module. At step 1541, the information security management module exchanges a security key at a start of the communication between the communication module and the server. At step 1542, the information security management module receives a security key from the server. At step 1543, the information security management module authenticates an identity of the server by verifying the security key. At step 1544, the information security management module analyzes the security key for potential cyber security threats. At step 1545, the information security management module negotiates an encryption key between the communication module and the server. At step 1546, the information security management module receives the encrypted data. At step 1547, the information security management module transmits the encrypted data to the server when no cyber security threat is detected.

In an embodiment, FIG. 15C shows the flowchart of securing the data through the cyber security module 1530. At step 1551, the information security management module 1532 is operable to: exchange a security key at a start of the communication between the communication module and the server. At step 1552, the information security management module receives a security key from the server. At step 1553, the information security management module authenticates an identity of the server by verifying the security key. At step 1554, the information security management module analyzes the security key for potential cyber security threats. At step 1555, the information security management module negotiates an encryption key between the communication module and the server. At step 1556, the information security management module receives encrypted data. At step 1557, the information security management module decrypts the encrypted data, and performs an integrity check of the decrypted data. At step 1558, the information security management module transmits the decrypted data to the communication module when no cyber security threat is detected.

In an embodiment, the integrity check is a hash-signature verification using a Secure Hash Algorithm 256 (SHA256) or a similar method.

In an embodiment, the information security management module is configured to perform asynchronous authentication and validation of the communication between the communication module and the server.

In an embodiment, the information security management module is configured to raise an alarm if a cyber security threat is detected. In an embodiment, the information security management module is configured to discard the encrypted data received if the integrity check of the encrypted data fails.

In an embodiment, the information security management module is configured to check the integrity of the decrypted data by checking accuracy, consistency, and any possible data loss during the communication through the communication module.

In an embodiment, the server is physically isolated from the system through the information security management module. When the system communicates with the server as shown in FIG. 15A, identity authentication is first carried out on the system and the server. The system is responsible for communicating/exchanging a public key of the system and a signature of the public key with the server. The public key of the system and the signature of the public key are sent to the information security management module. The information security management module decrypts the signature and verifies whether the decrypted public key is consistent with the received original public key or not. If the decrypted public key is verified, the identity authentication is passed. Similarly, the system and the server carry out identity authentication on the information security management module. After the identity authentication is passed on to the information security management module, the two communication parties, the system, and the server, negotiate an encryption key and an integrity check key for data communication of the two communication parties through the authenticated asymmetric key. A session ID number is transmitted in the identity authentication process, so that the key needs to be bound with the session ID number; when the system sends data to the outside, the information security gateway receives the data through the communication module, performs integrity authentication on the data, then encrypts the data through a negotiated secret key, and finally transmits the data to the server through the communication module. When the information security management module receives data through the communication module, the data is decrypted first, integrity verification is carried out on the data after decryption, and if verification is passed, the data is sent out through the communication module; otherwise, the data is discarded.

In an embodiment, the identity authentication is realized by adopting an asymmetric key with a signature.

In an embodiment, the signature is realized by a pair of asymmetric keys which are trusted by the information security management module and the system, wherein the private key is used for signing the identities of the two communication parties, and the public key is used for verifying that the identities of the two communication parties are signed. Signing identity comprises a public and a private key pair. In other words, signing identity is referred to as the common name of the certificates which are installed in the user's machine.

In an embodiment, both communication parties need to authenticate their own identities through a pair of asymmetric keys, and a task in charge of communication with the information security management module of the system is identified by a unique pair of asymmetric keys.

In an embodiment, the dynamic negotiation key is encrypted by adopting an Rivest-Shamir-Adleman (RSA) encryption algorithm. RSA is a public-key cryptosystem that is widely used for secure data transmission. The negotiated keys include a data encryption key and a data integrity check key.

In an embodiment, the data encryption method is a Triple Data Encryption Algorithm (3DES) encryption algorithm. The integrity check algorithm is a Hash-based Message Authentication Code (HMAC-MD5-128) algorithm. When data is output, the integrity check calculation is carried out on the data, the calculated Message Authentication Code (MAC) value is added with the header of the value data message, then the data (including the MAC of the header) is encrypted by using a 3DES algorithm, the header information of a security layer is added after the data is encrypted, and then the data is sent to the next layer for processing. In an embodiment the next layer refers to a transport layer in the Transmission Control Protocol/Internet Protocol (TCP/IP) model.

The information security management module ensures the safety, reliability, and confidentiality of the communication between the system and the server through the identity authentication when the communication between the two communication parties starts the data encryption and the data integrity authentication. The method is particularly suitable for an embedded platform which has less resources and is not connected with a Public Key Infrastructure (PKI) system and can ensure that the safety of the data on the server cannot be compromised by a hacker attack under the condition of the Internet by ensuring the safety and reliability of the communication between the system and the server.

The embodiments described herein include mere examples of systems and computer-implemented methods. It is, of course, not possible to describe every conceivable combination of components and/or computer-implemented methods for purposes of describing the one or more embodiments, but one of ordinary skill in the art can recognize that many further combinations and/or permutations of the one or more embodiments are possible. Furthermore, to the extent that the terms “includes,” “has,” “possesses,” and the like are used in the detailed description, claims, appendices and/or drawings such terms are intended to be inclusive in a manner similar to the term “comprising” as “comprising” is interpreted when employed as a transitional word in a claim.

Other specific forms may embody the present invention without departing from its spirit or characteristics. The described embodiments are in all respects illustrative and not restrictive. Therefore, the appended claims rather than the description herein indicate the scope of the invention. All variations which come within the meaning and range of equivalency of the claims are within their scope.

1-139. (canceled)

140. A system comprising:
a processor storing instructions in non-transitory memory that, when executed, cause the processor to:
receive a connection request from a responder device associated with a responder;
validate an authentication code associated with the responder;
establish a connection with the responder device;
receive a request for status information of a vehicle from the responder device;
determine a role and an authorization level of the responder from a database;
select, using a machine learning model, a segment of the status information of the vehicle based on the role and the authorization level of the responder; and
transmit the segment of the status information to the responder device.

141. The system of claim 140, wherein the authorization level comprises high-level access, mid-level access and basic level access.

142. The system of claim 140, wherein the role and the authorization level of the responder are determined based on a responder profile retrieved from the database.

143. The system of claim 140, wherein the machine learning model is trained using a dataset generated based on the status information.

144. The system of claim 143, wherein the status information comprises at least one of vehicle identification numbers (VIN), make and model, year of manufacture, license plate number, registration status of the vehicle, owner's name, owner's address, owner's contact details, insurance details, current location, speed, fuel level, mileage, maintenance history of the vehicle, accident history, service history, damage reports, traffic penalty information, recent incident information, occupant information, historical incident information, insurance claims, recall information, legal and compliance records, and customization history.

145. The system of claim 144, wherein the processor is operable to categorize, using the machine learning model, the status information into one or more segments.

146. The system of claim 145, wherein the processor is operable to determine a status information accessible level in each of the segments based on the authorization level of the responder.

147. The system of claim 146, wherein the processor is operable to adjust the status information accessible level in each of the segments based on real-time updates on the authorization level of the responder.

148. The system of claim 146, wherein the processor is operable to adjust the status information accessible level in each of the segments based on proximity of the responder device to the vehicle.

149. The system of claim 146, wherein the processor is operable to adjust the status information accessible level in each of the segments based on an urgency of a situation.

150. The system of claim 149, wherein the processor is operable to determine the urgency of the situation within the vehicle based on an input received from a sensor module associated with the vehicle.

151. The system of claim 146, wherein the processor is operable to adjust the status information accessible level in each of the segments based on historical access patterns and sensitivity score of the responder.

152. The system of claim 151, wherein the processor is operable to assign the sensitivity score to the responder based on a frequency and duration of historical access sessions to the status information and behavioral analysis of responder's interactions with the system.

153. The system of claim 146, wherein the processor is operable to adjust the status information accessible level in each of the segments based on recent vehicle activity.

154. A method comprising:
receiving a connection request from a responder device associated with a responder;
validating an authentication code associated with the responder;
establishing a connection with the responder device;
receiving a request for status information of a vehicle from the responder device;
determining a role and an authorization level of the responder from a database;
selecting, using a machine learning model, a segment of the status information of the vehicle based on the role and the authorization level of the responder; and
transmitting the segment of the status information to the responder device.

155. The method of claim 154, further comprising: receiving an additional status information request from the responder.

156. The method of claim 155, further comprising: retrieving additional status information based on the authorization level and the role of the responder upon receiving the additional status information request from the responder.

157. A non-transitory computer readable storage medium comprising a sequence of instructions, which when executed by a processor causes:
receiving a connection request from a responder device associated with a responder;
validating an authentication code associated with the responder;
establishing a connection with the responder device;
receiving a request for status information of a vehicle from the responder device;
determining a role and an authorization level of the responder from a database;
selecting, using a machine learning model, a segment of the status information of the vehicle based on the role and the authorization level of the responder; and
transmitting the segment of the status information to the responder device.

158. The non-transitory computer readable storage medium of claim 157, further comprising: encrypting the segment of the status information before transmitting the segment of the status information to the responder device.

159. The non-transitory computer readable storage medium of claim 158, further comprising: decrypting the segment of the status information upon receiving a valid authentication token from the responder device.
